(19) United States
(12) Patent Application Publication
(10) Pub. No.: US 2024/0310860 A1
(43) Pub. Date: Sep. 19, 2024

(54) METHODS AND APPARATUS FOR CONTROLLING AUTOMATED VEHICLES IN AN ENVIRONMENT USING VIRTUAL APPROVED PATHWAYS

(71) Applicant: Drobot, Inc., Greenville, SC (US)

(72) Inventors: Stijn J. Van De Velde, Simpsonville, SC (US); Ankit R. Verma, Greenville, SC (US); Siddhesh N. Bagkar, Troy, MI (US); Joseph M. Etris, Simpsonville, SC (US); Shaurya Panthri, Troy, MI (US); Chinmay Rathod, Troy, MI (US)

(73) Assignee: Drobot, Inc., Greenville, SC (US)

(21) Appl. No.: 18/674,231

(22) Filed: May 24, 2024

Related U.S. Application Data
(63) Continuation-in-part of application No. 17/826,104, filed on May 26, 2022, now Pat. No. 12,025,985.
(60) Provisional application No. 63/249,769, filed on Sep. 29, 2021.
(60) Provisional application No. 63/193,580, filed on May 26, 2021.

(51) Int. Cl. G05D 1/698; G01C 21/20; G05D 1/229; G05D 1/246; G05D 1/247; G05D 1/646; G05D 1/693

(52) U.S. Cl. CPC G05D 1/6987; G01C 21/20; G05D 1/2295; G05D 1/2462; G05D 1/247; G05D 1/646; G05D 1/693

(57) ABSTRACT

Systems and methods for controlling or guiding one or more automated vehicles and/or people (VOP) in an environment using virtual approved pathways (VAPs). Methods include determining a set of parameters associated with automated vehicles and/or people operating within an environment, including periodically obtaining a first set of parameters from a plurality of data sources deployed within an environment, in real-time.

### RELATED APPLICATIONS

This application is a continuation-in-part application of U.S. Non-provisional patent application Ser. No. 17/826,104 filed on May 26, 2022, and this application claims priority to U.S. Provisional Patent Application 63/249,769, filed Sep. 29, 2021, and U.S. Provisional Patent Application 63/193,580, filed May 26, 2021, each of which are incorporated herein by reference in their entirety.

### FIELD OF THE DISCLOSURE

The present disclosure relates to apparatus and methods to control navigation and operation of an automated vehicle or person (herein referred to as VOP) through an environment. More specifically, the present invention provides apparatus and methods for controlling a sequence of origination positions and destination positions, combined with acceptable acceleration, velocity, and action operation, such that the operation and travel of an automated vehicle or person (VOP) through a sequence of positions and actions is safe, effective, and efficient.

### BACKGROUND OF THE DISCLOSURE

Advancing safety in materials management and transportation remains a primary concern. The emergence of Automated Vehicles (AVs), encompassing self-driving cars, robots, and other intelligent mobile systems, necessitates robust safety protocols for their operation, especially since Automated Vehicles and people (together referred to as “VOPs”) increasingly are meant to operate and possibly collaborate within shared, often complex, and dynamic environments, from urban traffic networks to intricate industrial settings. Ensuring safe, effective, and efficient navigation, and possible collaboration, between AVs and/or people, operating within shared environments, remains a critical challenge.

Existing systems often rely solely on self-contained location tracking for VOPs. This narrow approach restricts an VOP's awareness to its immediate position, leaving it blind to the whereabouts of other VOP in its vicinity. This lack of comprehensive situational awareness may lead to inefficiencies and pose safety hazards in scenarios involving multiple moving entities.

Some other existing systems employ vision cameras and/or LiDAR which would require significant time and effort for programming or training VOPs to follow designated paths. Such training is vulnerable to changes in the environment. These training efforts are further hampered by the dynamic nature of environments. Consequently, changes in surroundings may render learned behaviors obsolete, diminishing the flexibility and reliability of the control system. Further, these sensor-based approaches also require significant computing power resulting in the need for larger batteries and ultimately affecting the operating range of the autonomous vehicles.

In some existing systems, such as Real-Time Locating Systems (RTLS), although the location of individual VOPs may be tracked, these systems, by themselves, lack the ability to recognize and respond to the presence of other VOPs in the environment. This limitation hinders efficient and safe multi-vehicle navigation, and possible collaboration, a critical requirement for many VOP applications to enable safe and efficient operations.

Therefore, there is a need to guide and control the automated vehicles or persons (VOPs) safely and efficiently along approved paths that avoid obstacles and areas less desirable for travel.

### SUMMARY OF THE DISCLOSURE

The following presents a simplified summary of some embodiments of the disclosure in order to provide a basic understanding of the embodiments. This summary is not an extensive overview of the embodiments. It is not intended to identify key/critical elements of the embodiments or to delineate the scope of the embodiments. Its sole purpose is to present some embodiments in a simplified form as a prelude to the more detailed description that is presented below.

In one aspect, a method for controlling one or more VOPs in an environment using virtual approved pathways (VAPs) is disclosed. The method includes determining, by a processor, a set of parameters associated with a VOP. The set of parameters comprise at least one of a class, capabilities, characteristics, and requirements associated with the VOP. The VOP is dynamically configured to navigate from a source point to a destination point based on one or more tasks being requested. The method further includes continuously obtaining, with the processor, a first set of parameters from a plurality of data sources deployed within an environment, in real-time. The first set of parameters comprise sensor data, one or more properties associated with a plurality of objects, one or more navigation objectives, a plurality of pre-defined rules associated with each object within the environment, a plurality of priority levels, and one or more user-defined requirements. The plurality of objects includes at least one of sensors, one or more VOPs, one or more load objects, one or more cart objects, and one or more obstacles, one or more computing devices, one or more user devices, one or more real-time location system (RTLS) tags. Further, the method includes determining, with the processor, one or more navigation plans for capable VOPs predicted to be available at the requested time, and dynamically configured to navigate from the source point to the destination point based on the obtained first set of parameters. Each of the one or more navigation plans corresponds to at least one of a plurality of classes of VOPs, a plurality of environmental conditions, the plurality of pre-defined rules and the plurality of priority levels, the one or more properties associated with each object within the environment, the one or more navigation objectives and the one or more user-defined requirements. Furthermore, the method includes correlating, with the processor, each of the determined one or more navigation plans with the one or more tasks to be performed by the one or more VOPs, at specific times, the at least one of the obtained first set of parameters and the determined set of vehicle parameters, using a data driven model. Further, the method includes determining, with the processor, an optimal navigation plan for the VOP based on the correlation, wherein the optimal navigation plan includes at least one Virtual Approved Pathway (VAP) connecting the source point with the destination point via a plurality of path points, dynamic properties to be configured with the VOP, and one or more operational rules to be followed by the VOP while navigating in the at least one Virtual Approved Pathway (VAP).

Additionally, the method includes navigating, with the processor, the VOP within the environment based on the determined optimal navigation plan. The VOPs are guided by one or more waypoints acting as path indicators. Further, the method includes determining, with the processor, whether the optimal navigation plan is to be updated based on the plurality of environmental conditions, a current position of the destination point, a predicted position of the destination point, possible movements of the destination point, and the first set of parameters. Moreover, the method includes updating, with the processor, at least a portion of the optimal navigation plan based on the plurality of environmental conditions and the first set of parameters obtained in real-time.

In another aspect, a control system for managing virtual approved pathways (VAPs) for one or more VOPs in an environment is disclosed. The control system includes a processor, a memory coupled to the processor. The memory includes a Virtual Approved Pathway (VAP) and VOP management module stored in the form of machine-readable instructions executable with the processor to determine a set of parameters associated with a VOP. The set of VOP parameters comprise at least one of classes, capabilities, characteristics, and requirements associated with the VOP. The VOP is configured to navigate from a source point to a destination point. Further, the control system is configured to continuously obtain a first set of parameters from a plurality of data sources deployed within an environment in real-time. The first set of parameters comprise sensor data, one or more properties associated with a plurality of objects, one or more navigation objectives, a plurality of pre-defined rules associated with each object within the environment, a plurality of priority levels, and one or more user-defined requirements. The plurality of objects includes at least one of: sensors, one or more VOPs, a load object, a cart object, one or more obstacles, one or more computing devices, one or more user devices, or one or more real-time location system (RTLS) tags. The control system is configured to determine one or more navigation plans for the VOP to navigate from the source point to the destination point based on the obtained first set of parameters. Each of the one or more navigation plan corresponds to at least one of a plurality of classes of VOPs, a plurality of environmental conditions, the plurality of pre-defined rules and the plurality of priority levels, the one or more properties associated with each object within the environment, the one or more navigation objectives and the one or more user-defined requirements.

Further, the control system is configured to correlate each of the determined one or more navigation plans with at least of one of the obtained first set of parameters and the determined set of parameters using a data driven model. Moreover, the control system is configured to determine an optimal navigation plan for the VOP based on the correlation. The optimal navigation plan includes at least one Virtual Approved Pathway (VAP) connecting the source point with the destination point via a plurality of path points, dynamic properties to be configured with the VOP and one or more operational rules to be followed by the VOP while navigating in the at least one Virtual Approved Pathway (VAP). The control system is configured to navigate or guide the VOP within the environment based on the determined optimal navigation plan. The VOPs are guided by one or more waypoints acting as path indicators. Further, the control system is configured to determine whether the optimal navigation plan is to be updated based on the plurality of environmental conditions, a current position of the destination point, a predicted position of the destination point, possible movements of the destination point, and the first set of parameters. Additionally, the control system is configured to update at least a portion of the optimal navigation plan based on the plurality of environmental conditions and the first set of parameters obtained in real-time.

In yet another aspect of the invention, an industrial environment for managing the Virtual Approved Pathways (VAPs) is disclosed. The industrial environment includes a plurality of objects including at least one of sensors, one or more VOPs, one or more load objects, one or more cart objects, and one or more obstacles, one or more computing devices, one or more real-time location system (RTLS) tags. The industrial environment includes a plurality of user devices communicatively coupled to the plurality of objects via a communication network. The plurality of user devices includes a user interface for interacting and modifying visual representations of the environment. The industrial environment further includes a control system communicatively coupled to the plurality of objects and the plurality of user devices via the communication network. The control system is configured to perform the method steps described above.

It will be appreciated that any flow charts, flow diagrams, state transition diagrams, pseudo code, and the like represent various processes which may be substantially represented in computer readable medium and so executed by a computing device or processor, whether or not such computing device or processor is explicitly shown.

### BRIEF DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 is a block diagram of an exemplary network architecture capable of controlling or guiding VOPs using Virtual Approved Pathways (VAPs), in accordance with embodiments of the present disclosure;

FIG. 2A is a schematic representation of an exemplary environment comprising an exemplary vehicle co-located with a tag which communicates with one or more anchors, in accordance with embodiments of the present disclosure;

FIG. 2B is a schematic representation of another exemplary environment with multiple autonomous vehicles and/or a person (VOP) co-located with respective tags which communicate with the one or more anchors, in accordance with embodiments of the present disclosure;

FIG. 3 is a schematic representation of example virtual approved paths for multiple vehicles and a mobile target, in accordance with embodiments of the present disclosure;

FIG. 4A-C is a schematic representation of an exemplary graphical user interface screen depicting a virtual representation of the environment with various Virtual Approved Pathways (VAPs) for an autonomous vehicle or person (VOP), in accordance with embodiments of the present disclosure;

FIG. 5 is a schematic representation of an exemplary graphical user interface screen depicting a portion of the virtual representation while determining an optimal navigation plan for the VOP, in accordance with embodiments of the present disclosure;

FIG. 6 is a schematic representation depicting an exemplary process of defining Virtual Approved Pathways (VAPs), in accordance with embodiments of the present disclosure;

FIG. 7A-B are schematic representations of an exemplary graphical user interface screen depicting a portion of the virtual representation for selecting optimal trajectory (or trajectories) among best possible trajectories for the VOP, in accordance with embodiments of the present disclosure;

FIG. 8 is a block diagram of an exemplary smart device depicting various hardware components of the smart device, in accordance with embodiments of the present disclosure;

FIG. 9 is an exemplary block diagram representation of a control system, depicting various hardware components, capable of controlling or guiding VOPs using Virtual Approved Pathways (VAPs), in accordance with embodiments of the present disclosure; and

FIG. 10 is a flow chart depicting an exemplary method of controlling or guiding VOPs using Virtual Approved Pathways (VAPs), in accordance with embodiments of the present disclosure.

### DETAILED DESCRIPTION

The embodiments herein and the various features and advantageous details thereof are explained more fully with reference to the non-limiting embodiments that are illustrated in the accompanying drawings and detailed in the following description. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, and the like. When a process corresponds to a function, its termination may correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

### Glossary

Administrator: a person or entity defining the rules to be respected and/or setting the objectives to be achieved, this includes drawing, recording, or otherwise defining (Virtual) (Approved) Pathways or (Virtual) (Approved) Pathway Sections.

Approved Pathway: a type of Pathway that a certain VOP is allowed to use to travel within an Environment (at certain times and/or under certain conditions or circumstances), to perform certain Tasks and/or accomplish certain objectives.

Asset: An Object or VOP within an Environment. An Asset may be (re)presented as a Virtual Element, by a computer system such as a Control System, on a digital representation of an Environment, such as a Map or Floor Plan or 3D rendering. An Asset may have certain Properties and/or Rules associated with it.

Augmented Reality/Mixed Reality/Virtual Reality or Extended Reality Device or AR/MR/VR Device: an electronic device, such as a smart phone, tablet, or head-mounted display, that uses sensors and algorithms to superimpose digital or virtual elements, such as certain images or information, in real-time onto the user's perception of the (“real world”) physical environment, allowing for interactive and immersive experiences. For the purposes of this document, Augmented Reality (AR), Mixed Reality (MR), Virtual Reality (VR), and Extended Reality (ER) may be used interchangeably.

Augmented Reality or AR or Mixed Reality (MR), or Virtual Reality (VR), or Extended Reality (ER): a technology that enhances the real-world environment by overlaying digital information (such as images, text, or animations) onto a user's view of the physical world. This integration is achieved through devices like smartphones, tablets, or specialized glasses, which use cameras, sensors, and display technology to superimpose virtual elements onto the user's perception of the physical world, in real-time, AR/VR/MR/ER enhances perception and interaction with the real world, allowing users to see and interact with contextual digital enhancements that appear to coexist within their immediate surroundings. For the purposes of this document, Augmented Reality (AR), Mixed Reality (MR), Virtual Reality (VR), and Extended Reality (ER) are used interchangeably.

Automated Vehicle or AV: a vehicle that is at least partially automated, i.e., able to navigate, travel, and operate within a certain Environment in a partially or fully automated fashion. A Robot is an example of an Automated Vehicle, and some examples of Robots include automated guided vehicles (AGVs), autonomous mobile robots (AMRs), humanoid robots, and drones.

Capability: the ability to perform a certain task or activity, based on for example competency, physical abilities, and/or Environmental Conditions.

Capacity: the ability to perform a certain task or activity, based on the time available.

Cart: an Object that may be used to hold and transport other Objects within an Environment, a Cart may be (re)presented as a Virtual Element, by a computer system such as a Control System, on a digital representation of an Environment, such as a Map or Floor Plan or 3D rendering. A Cart may have certain Properties and/or Rules associated with it.

Cart Property: a property that applies to a Cart.

Characteristic: a distinguishing feature or quality that defines and differentiates VAPs, VOPs, and/or Assets.

Computing devices: computers or a computation capable device for performing some computation within itself. For example, a positioning server, a local server, a local control station or a device of a Person or a technician or the like. This may include for example, any mobile, tablet, PC, wearable device, or any electronic devices.

Control System: a computer system that stores and/or accesses certain data and that runs certain algorithms to interpret such data, including but not limited to data provided by a VOP, and possibly provided by other VOPs operating in the same Environment, and/or data captured through certain Sensors present in the Environment, to help a VOP make decisions related to e.g. feasible or optimal travel trajectories. A Control System may either be carried by one or more VOPs (sometimes referred to as “on-board”), and/or maintained in the Environment (sometimes called a “local server”), and/or maintained remotely, e.g., in a private or public Cloud (sometimes called a “Cloud server”).

Destination or Destination Point or Destination Position or Destination Location: the target Location of a VOP or Object (incl. Obstacle). A Destination may be (re)presented as a Virtual Element, by a computer system such as a Control System, on a digital representation of an Environment, such as a Map or Floor Plan or 3D rendering. A Destination may have certain Properties and/or Rules associated with it.

Deviation: refers to the maximum distance a VOP is allowed to deviate from a VAP to, for example, optimize its travel trajectory.

Environment or Operating Environment: the (defined/delimited/demarcated) physical environment, in 2D or 3D space, within which a VOP operates and navigates to perform certain tasks (“work”) and achieve certain objectives. An Environment may have certain Properties and/or Rules associated with it.

Environmental Characteristics: certain characteristics of the Environment which typically remain unchanged over time (for example location and dimensions of aisleways). These Environmental Characteristics may possibly be observed and measured by the VOPs that are operating within the Environment.

Environmental Conditions: certain conditions or circumstances within the Environment, which typically evolve over time, as observed and measured by the VOPs operating within the Environment, or as observed and measured by certain Sensors within the Environment. The current location of one or more VOPs and/or Objects within the Environment may be considered part of the Environmental Conditions.

Existing VAP or Original VAP: a VAP that is of a more “predefined” or more “static” nature (representing some or all the possible Routes a Control System could select from to establish one or more Trajectories for one or more VOPs), as opposed to a “Temporary VAP”, which is of a more “temporary” nature (to for example help address some temporary need).

Free Roam Zone or Free-Roam Zone: a special type of Zone within which a specific VOP is allowed to travel freely, without the need for its Control System to restrict Routes and Trajectories to VAPs or VAP Sections (at certain times and/or under certain conditions, possibly including certain Environmental Conditions).

Intersection Point: a Location where 2 Pathways intersect.

Load: an Object that needs to be, or is being, relocated (transported) within an Environment. A Load may be (re)presented as a Virtual Element, by a computer system such as a Control System, on a digital representation of an Environment, such as a Map or Floor Plan or 3D rendering. A Load may have certain Properties and/or Rules associated with it.

Load Property: a property that applies to a Load.

Location: a specific place (or position) in the Environment (as defined by an associated 2D or 3D coordinates).

Map or Floor Plan: a visual (2D or 3D) representation of the Environment, typically including fixed Objects or Obstacles, such as walls, doors, equipment, other Virtual Elements within the Environment and the like, as well as pedestrian or other aisleways, and possibly including the (current) location of mobile Assets.

Navigate: to decide how to Travel (and/or to actually Travel) between various locations within an Environment.

Navigation Plan: a possible travel route, determined by a Control System, to enable a certain VOP to perform a certain Task within a certain Environment. A Control System typically determines and evaluates multiple Navigation Plans, across multiple VOPs and VAPs, in order to select the Optimal Navigation Plan and assign it to the best-positioned (“optimal”) VOP, in view of all the relevant Properties, Operational Rules, and Objectives involved. Besides a specific travel route, or Trajectory, a Navigation Plan also includes all additional planned parameters (e.g. the target minimum, average, and/or maximum speeds at which a VOP is directed to travel along the chosen route) as determined by all the Properties and Rules associated with the Task (and any Loads and/or Carts involved), as well as any VAPs (or VAP Sections) and Zones and Stations (or other Waypoints) and the like involved along the planned route during the VOPs performance of the Task.

No Go Zone or No-Go Zone: a special type of Zone where a specific VOP (or Class of VOPs) is not allowed to enter or travel (at certain times and/or under certain conditions, possibly including certain Environmental Conditions).

Object: a physical item within an Environment that typically can move or be moved (e.g., part, tool, fixture, cart, pallet, box, bin, tray, folder, pallet jack, forklift, tugger train, scissor lift, boom lift, and the like). VOPs (such as Automated Vehicles or People), Robots, Obstacles, Sensors, Computing systems, Communication interfaces, RTLS tags, RTLS anchors, Network devices or the like, may be considered to be Objects. An Object may be (re)presented as a Virtual Element, by a computer system such as a Control System, on a digital representation of an Environment, such as a Map or Floor Plan or 3D rendering. An Object may have certain Properties and/or Rules associated with it.

Objective or Objective Set: one or more specific objectives to be achieved by a VOP while performing a particular Task, or a set of multiple (consecutive or parallel) Tasks. (For example: “safely”, “on time”, “shortest route”, “quickest travel time”, and the like.)

Obstacle: an Object that may prevent a VOP from navigating and traveling freely, possibly causing an adjustment in Trajectory (e.g., through some avoidance maneuver). An Obstacle may be (re)presented as a Virtual Element, by a computer system such as a Control System, on a digital representation of an Environment, such as a Map or Floor Plan or 3D rendering. An Obstacle may have certain Properties and/or Rules associated with it.

Obstacle Avoidance Distance: refer to the maximum distance a VOP is allowed to deviate from a VAP while performing an obstacle avoidance maneuver (i.e., a special case of Deviation).

Operate: to perform certain Tasks or activities (“work”). For example: VOPs performing certain tasks within the Environment.

Operational Rules: the entire collection of Rules that an VOP should abide by, based on all the Rules that are applicable to the VOP along the Trajectory traveled by the VOP while performing a Task or set of Tasks (e.g. including any VAP Rules, Zone Rules, and/or Station Rules that apply to the VOP while it is traveling to and/or through certain Stations and/or Zones, along certain VAPs). Operational Rules typically help determine Navigation Plans.

Operator: a Person who performs certain activities within an Environment, and while performing such activities, at times may encounter or interact with a VOP. An Operator may be (re)presented as a Virtual Element, by a computer system such as a Control System, on a digital representation of an Environment, such as a Map or Floor Plan or 3D rendering. An Operator may have certain Properties and/or Rules associated with them.

Optimal Navigation Plan: the specific Navigation Plan chosen by a Control System and assigned to a selected VOP to perform a certain Task.

Optimal Trajectory: the specific Trajectory chosen by a Control System for a selected VOP to perform a certain Task.

Path Point: a Location within the Environment, used to define a Pathway or a Pathway Section. Typically, the start and finish of a Pathway, or a Pathway Section, as well as any inflection points along such Pathway, would be considered Path Points. A Path Point may be (re)presented as a Virtual Element, by a computer system such as a Control System, on a digital representation of an Environment, such as a Map or Floor Plan or 3D rendering. A Path Point may have certain Properties and/or Rules associated with it.

Pathway or Path: a designated path or route that may be used by VOPs to navigate through an Environment while performing certain tasks. All parts of a Pathway should be connected in some way. A Pathway may contain one or more closed loops. A Pathway may also consist of an entire network of paths or routes throughout an Environment. Multiple Pathways may exist within the same Environment. Each identifiable subsection of a Pathway may be considered to be a Pathway in itself, as long as all the parts of the subsection are connected. A Pathway may be considered to consist of multiple smaller Pathways. Sections of separate Pathways may be combined to create one or more larger Pathways. A Pathway may be represented as a Virtual Element, by a computer system such as a Control System, on a digital representation of an Environment, such as a Map or Floor Plan or 3D rendering. A Pathway may have certain Properties and/or Rules associated with it.

Pathway Section or Path Section: a segment of a Pathway or Path. A Pathway Section may be (re)presented as a Virtual Element, by a computer system such as a Control System, on a digital representation of an Environment, such as a Map or Floor Plan or 3D rendering. A Pathway Section may have certain Properties and/or Rules associated with it.

Person/People: (a) human operator(s), typically performing certain tasks or activities (“work”). A Person or People may be (re)presented as (a) Virtual Element(s), by a computer system such as a Control System, on a digital representation of an Environment, such as a Map or Floor Plan or 3D rendering. A Person or People may have certain Properties and/or Rules associated with them.

Pose: the combination of Position and Orientation.

Position: The Location of a VOP or Object (incl. e.g., an Obstacle).

Property: A Capability, Capacity, Characteristic, Requirement, or other attribute.

Property Matching: to identify Assets (for example VOPs and VAPs) for which certain Properties match (for example certain VOP Properties match certain VAP Properties) enabling certain activities and/or driving certain behaviors.

Real-Time Location System (RTLS), (RTLS) Tags, and (RTLS) Anchors: a technology used to automatically track the location and movement of Objects (incl. e.g., Robots) or People in real time within a defined 2D or 3D environment. An RTLS uses “Tags” (also called for example “sensors”. “trackers”, or “labels”) attached to the Objects or worn by the People being tracked, and a network of “Anchors” (also referred to as e.g., “antennas”, “receivers”, “readers”, “sensors”, or “beacons”) mounted in the Environment. Anchors and Tags exchange wireless (e.g., RF) signals (using e.g., UWB, BLE, RFID, Wi-Fi, LoRa, 5G, GPS, GPS/RTK, or any other suitable technology) to determine the positions and movements of the Tags, thereby determining the positions and movements of the Objects or People that the Tags are attached to or worn by. In certain cases, a mobile phone or tablet computer could function as a Tag. Instead of using RF signaling, the RTLS may also use cameras present in the Environment, including cameras mounted on some or all of the VOPs. The information is typically relayed to a software platform that processes the data and displays the locations on a map in real time.

Requirement: a necessary condition or specification that must be met for a particular purpose or function.

Robot or Bot: a programmable device, consisting of mechanical and electronic components, and equipped with Sensors and algorithms that enable it to perform certain tasks autonomously or semi-autonomously, including navigating and operating (semi)autonomously within a certain (2D and/or 3D) Environment. This includes responding to environmental inputs or pre-defined programming criteria. Robots typically support and interact with human operators and may possess mobility (such as in the case of Automated Guided Vehicles and Autonomous Mobile Robots), flight capabilities (as with drones), or anthropomorphic features (as in humanoid robots). A Robot may be represented as a Virtual Element, by a computer system such as a Control System, on a digital representation of an Environment, such as a Map or Floor Plan or 3D rendering. A Robot may have certain Properties and/or Rules associated with it. A Robot is a type of Automated Vehicle.

Route or Possible Route: a set of coordinates defining the location of a Pathway, such as a VAP, within an Environment. Also, a collection of selected Pathways and/or Pathway Sections that connect two Path Points (i.e., 2 Locations within the Environment). A Route may be (re)presented as a Virtual Element, by a computer system such as a Control System, on a digital representation of an Environment, such as a Map or Floor Plan or 3D rendering. A Route may have certain Properties and/or Rules associated with it.

Rule: a prescribed guideline that influences or controls the behavior of a VOP or Asset.

Sensor: a device or component used to detect and/or measure physical properties or changes in the Environment.

Short-Term Trajectory or Travel Intent: the “short-term” planned (or “intended”) Trajectory of a VOP while traveling within an Environment. For example, the next 10 feet or the next 10 seconds worth of Trajectory as planned by or for a VOP (whereby the amount of Trajectory considered “short term”, as expressed in distance or time, may be a parameter that is either defined by an Administrator or Operator, or defined—and possibly adjusted dynamically—by a Control System, depending on e.g. certain VAP Rules and/or Environmental Conditions).

Station: a fixed (or “stationary”) Location within the Environment, e.g., serving as a pick-up and/or drop-off point. A Station may be (re)presented as a Virtual Element, by a computer system such as a Control System, on a digital representation of an Environment, such as a Map or Floor Plan or 3D rendering. A Station may have certain Properties and/or Rules associated with it.

Station Property: a property that applies to a Station.

Station Rule: a Rule that applies to a Station.

Target or Target Point or Target Position or Target Location: a mobile (or “dynamic”) Location within the Environment, reflecting the position of some mobile Asset within the Environment (and, typically provided by a Real-Time Location System). A Target may be represented as a Virtual Element, by a computer system such as a Control System, on a digital representation of an Environment, such as a Map or Floor Plan or 3D rendering. A Target may have certain Properties and/or Rules associated with it.

Task: a specific operation or set of actions (to be) performed by a VOP, to achieve a desired outcome or objective, often involving some navigation and travel within an Environment. A Task may be represented as a Virtual Element, by a computer system such as a Control System, on a digital representation of an Environment, such as a Map or Floor Plan or 3D rendering. A Task may have certain Properties and/or Rules associated with it.

Temporary VAP or Ad Hoc VAP: a VAP that is of a more “temporary” nature (to for example help address some temporary need), as opposed to an Existing VAP (also referred to as an Original VAP) which is of a more “predefined” or “static” nature.

Trajectory or Planned Trajectory: a path or “line of travel”, as planned by a Control System, consisting of one or more Pathways or Path Sections, such as VAPs or VAP Sections, and possibly already partially or entirely traveled by a VOP, while operating within an Environment. Hence, while a Route shows the VAPs and/or VAP Sections where a VOP is theoretically or technically able to travel, the Trajectory is the actual combination of the specific VAPs and/or VAP Sections chosen for a VOP to actually travel from one location to another. A Trajectory may be represented as a Virtual Element, by a computer system such as a Control System, on a digital representation of an Environment, such as a Map or Floor Plan or 3D rendering. A Trajectory may have certain Properties and/or Rules associated with it. A Trajectory is typically part of a Navigation Plan.

Travel: to physically move, or physical movement (typically between various locations within an Environment).

User Device: a user interface for viewing, interacting with, and modifying visual representations of the Environment and some or all the Virtual Elements that exist within or are associated with the Environment. A User Device can also be used to communicate certain information (e.g., directions) from a control system to one or more Persons utilizing the User Device.

Virtual Approved Pathway or VAP: a type of Pathway that is both virtual and approved (i.e., a Pathway that is both a Virtual Pathway and an Approved Pathway), and that is defined by a set of coordinates within a certain coordinate system, and that comprises certain Properties and certain Rules.

VAP Intersection (Point): a Location (as defined by its coordinates) where two VAPs intersect with each other.

VAP Priority or VAP Priority Level: a type of VAP Property that may be relevant in the context of certain VAP Rules, by defining the relative priority of one VAP's Properties and Rules over other VAPs' Properties and Rules, thereby for example deciding which Routes and Properties may apply to certain VOPs under certain circumstances, incl. e.g., certain Environmental Conditions.

VAP Property: a Property that applies to a VAP and/or a VAP Section (for example a minimum or maximum bend radius, “risk level”, usage characteristics, and the like.)

VAP Rule: a Rule that applies to a VAP and/or a VAP Section, that may influence or control the behavior of certain VOPs traveling along the VAP or VAP Section (incl. for example deviation and obstacle avoidance distance).

VAP Section: a segment of a VAP (for example the part of a VAP that lies between two VAP Intersections), VAP and VAP Section are typically used interchangeably, hence when referring to a VAP, this could be either a VAP or a VAP Section.

Virtual Element: anything that reflects some aspect or “element” of a (“physical”) Environment and which is defined digitally in a computer system, such as a Control System. This includes e.g., VAPs, VAP Sections, Routes, Trajectories, Zones, Path Points, Waypoints, Stations, Destinations, Targets, and the like. Certain Properties or Rules associated with an Object or a VOP may be considered to be Virtual Elements as well. A VOP's Travel Intent may be considered to be a Virtual Element as well. Any Virtual Element may have certain Properties and/or Rules associated with it. Virtual Elements (as well as some or all of their possible Properties and/or Rules) may be shown, by a computer system such as a Control System, on a digital representation of an Environment, such as a Map or Floor Plan or 3D rendering, including by using Augmented Reality (or “AR”).

Virtual Pathway: a type of Pathway that is defined virtually, stored in a computer system (and that may not be visible to the human eye in the Environment).

VOP: (Automated) Vehicle or Person. In plural, VOPs refers to “(Automated) Vehicles or Persons” or “(Automated) Vehicles or People”. VOP can also refer to a Class of (Automated) Vehicles or People, whereby “class” can also be referred to as “category,” “type,” or “family”. The navigation and travel of Automated Vehicles can be influenced or controlled by Approved Virtual Pathways, as can the navigation and travel of People. Therefore, we at times refer to “(Automated) Vehicle or Person” as “VOP”, or to “(Automated) Vehicles or People” as “VOPs”, to be more concise in our explanations and descriptions. A VOP may be (re)presented as a Virtual Element, by a computer system such as a Control System, on a digital representation of an Environment, such as a Map or Floor Plan or 3D rendering. A VOP may have certain Properties and/or Rules associated with it. One Example of VOP may include Robot or Vehicle or Person, or: Class of Robots/Vehicles or People (“class” can also be referred to as e.g., “category” or “type” or “family”). The navigation and travel of Robots/Vehicles can be influenced or controlled by Virtual Approved Pathways, as can the navigation and travel of People. Therefore, at times “Robot/Vehicle or Person” refer to as “VOP”, or to “Robots/Vehicles or Persons” or “Robots/Vehicles or People” as “VOPs”, to be more concise in our explanations and descriptions.

VOP Management Module: a module, as part of a Control System, which is responsible for monitoring and controlling (or guiding, in case of People) the actions and behaviors of a Vehicle or Person (“VOP”) while they are performing a certain Task in accordance with an (Optimal) Navigation Plan. In case of an Autonomous Vehicle, the VOP Management Module is typically able to directly control the actions and behaviors of the Autonomous Vehicle, whereas in case of a Person, the VOP Management Module will typically only be able to guide the Person, e.g., through feedback and instructions communicated to the Person through a User Device.

VOP Orientation: the specific direction in which a VOP is pointed relative to its Environment (typically defined by the angular relationship between the VOP's own “local” frame of reference and the predefined “global” coordinate system being used in the Environment, determining how the VOP is rotated about its axes compared to the global coordinate system)

VOPC: a type of VOP, specifically a VOP that is pulling or pushing one or more Carts. A VOPC, as well as possibly the one or more Carts that it is pulling and/or pushing, may be (re)presented as a Virtual Element, by a computer system such as a Control System, on a digital representation of an Environment, such as a Map or Floor Plan or 3D rendering. A VOPC may have certain Properties and/or Rules associated with it.

VOPC Property: a property that applies to a VOPC (a Vehicle or Person pulling or pushing one or more Carts).

VOPL Property: a property that applies to a VOPL (a Vehicle or Person carrying one or more Loads).

VOPL: a type of VOP, specifically a VOP that is carrying one or more Loads. A VOPL, as well as possibly the one or more Loads that it is carrying, may be (re)presented as a Virtual Element, by a computer system such as a Control System, on a digital representation of an Environment, such as a Map or Floor Plan or 3D rendering. A VOPL may have certain Properties and/or Rules associated with it.

VOPLC: a type of VOP, specifically a VOP that is carrying one or more Loads while simultaneously pulling and/or pushing one or more Carts. A VOPLC, as well as possibly the one or more Loads that it is carrying and/or the one or more Carts that it is pulling and/or pushing, may be (re)presented as a Virtual Element, by a computer system such as a Control System, on a digital representation of an Environment, such as a Map or Floor Plan or 3D rendering. A VOPLC may have certain Properties and/or Rules associated with it.

VOP Parameters: the type or Class of VOP, together with all VOP Properties and VOP Rules associated with a VOP.

VOP Property: a property that applies to a VOP, for example: width, length, weight, load carrying capability, pulling or pushing capability, and the like.

VOP Rules: Rules associated with a VOP (or Class of VOPs).

Waypoint: a Location on a Pathway that may be used to guide a VOP during its navigation and travel (Path Points typically serve as Waypoints. Waypoints may be considered to be Path Points, but not all of them are required to define the Route of a Pathway). A Waypoint may be (re)presented as a Virtual Element, by a computer system such as a Control System, on a digital representation of an Environment, such as a Map or Floor Plan or 3D rendering. A Waypoint may have certain Properties and/or Rules associated with it.

Zone: a specifically delineated area (in 2D or 3D space) within an overall Environment. A Zone is characterized by its boundaries and is typically defined for specific functions, usage, or characteristics within a larger setting (this concept is crucial for organizing space, managing activities, and directing movements within various environments such as industrial settings, office layouts, or public areas). A Zone may be (re)presented as a Virtual Element, by a computer system such as a Control System, on a digital representation of an Environment, such as a Map or Floor Plan or 3D rendering. A Zone may have certain Properties and/or Rules associated with it (to e.g., help in establishing control, safety, and efficiency by segmenting larger spaces into manageable, functional areas).

Zone Property: a property that applies to a Zone.

Zone Rule: a Rule that applies to a Zone.

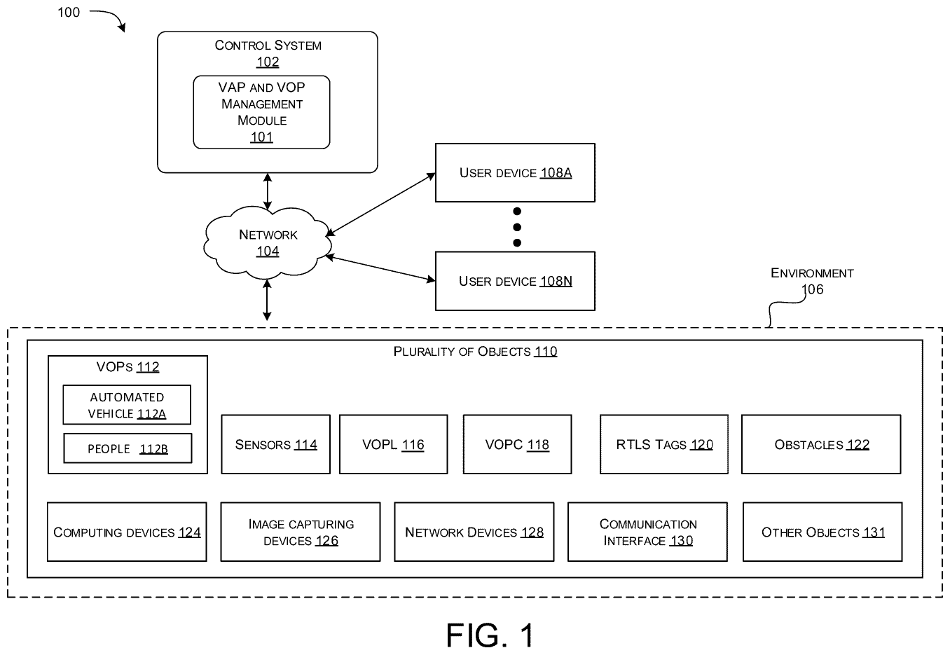

Referring now to the drawings, and more particularly to FIG. 1 through FIG. 10, where similar reference characters denote corresponding features consistently throughout the figures, there are shown preferred embodiments, and these embodiments are described in the context of the following example system and/or method.

FIG. 1 is a block diagram of an exemplary network architecture 100 capable of controlling or guiding VOPs using Virtual Approved Pathways (VAPs), in accordance with embodiments of the present disclosure. The network architecture 100 may include a control system 102 communicatively coupled to a plurality of objects 110 (also referred as object 110, objects 110, or the like) within an environment 106 via a network 104. The control system 102 may further be connected to one or more user devices 108A-N (collectively referred to as user devices 108A-N) via the network 104 (also referred herein as communication network 104).

The environment 106 may be a manufacturing facility or other industrial environment, warehouse, construction site, clinic or hospital, retirement community, eldercare facility, school, mall or store or other shopping area, restaurant, entertainment space, any public area, city environment, indoor or outdoor setup, and the like. The environment 106 may be geographically distributed. Each of the environment 106 may include the plurality of objects 110. The plurality of objects 110 may include, different types/classes of assets such as, for example, but not limited to, materials, equipment, machines, sensors 114, actuators, one or more VOPs 112 (also referred herein as Vehicle or Person 112, Vehicles or Persons 112, Vehicles or People 112, automated vehicle 112, automated vehicles 112, AV 112, AVs 112, VOP 112, VOPs 112, Vehicle 112, Vehicles 112, or the like), one or more load objects 116, one or more cart objects 118, and one or more obstacles 122, one or more computing devices 124, one or more real-time location system RTLS tags 120 (also referred herein as tag or tags), one or more image capturing devices 126 (such for example, but not limited to cameras, image sensors, surveillance cameras, vision camera and the like), network devices 128, communication interface 130 and the like, located in the environment 106. Each of the plurality of objects 110 are capable of communicating with the control system 102 using respective communication interfaces 130 via communication links, such as for example, but not limited to, the Internet or a network 104. Also, the plurality of objects 110 are capable of communicating with each other using respective communication interfaces 130 via communication links (not shown). The communication links may be wired or wireless links.

Further, in the environment 106, some of the plurality of objects 131 may not be capable of directly communicating with the control system 102. For example, the plurality of objects 131 may be one or more obstacles, parts, tools, fixtures, carts, pallets, boxes, bins, trays, folders, pallet jacks, forklifts, tugger trains, scissor lifts, boom lifts, or the like. In an alternate embodiment, some of the plurality of objects 110 may communicate with the control system 102 via another object. For example, one object may be an IoT gateway, and the other object may be robots, sensors, actuators, machines, or other field devices which communicate to the control system 102 via the IoT gateway. In such a case, each of the plurality of objects 110 may have some form of sensing element either mounted on it or is carried along with, to capture relevant data of the objects 110 and communicate with other objects 131 capable of communicating via a hub or a gateway or directly with the control system 102. In some embodiments, the plurality of objects 110 may carry RTLS Tags 120 which may be used to track and communicate their real-time location to the control system 102 and, which may be used to communicate some or all of the sensor data collected by some of the objects 131 to other objects 131 and/or a control system 102 or to the control system 102, which can then relay some of the information to some or all of the other objects 131 present or active within the same environment 106.

Some of the plurality of objects 110 may have an operating system and at least one software program for performing desired operations in the environment 106. Also, the plurality of objects 110 may run software applications for collecting, and pre-processing environment data, sensor data, location data, or the like, and transmitting the pre-processed data to the control system 102.

In some embodiments, the VOPs 112 may include at least one of the Automated Vehicles 112A and/or Persons 112B. The Automated Vehicles 112A may include Robots, Drones 140, Autonomous Vehicles and the like. The Persons 112B may include human agents, carrying one or more devices and/or one or more RTLS tags 120 and/or one or more sensors. The VOPs 112 may include any other type of movable objects either on its own or through some means.

The control system 102 may be a remote server or a local control system or a web server or a cloud infrastructure capable of providing cloud-based services such as data storage services, data analytics services, data visualization services, and the like based on the environment data. The control system 102 may be a part of public cloud or a private cloud. Alternatively, the control system 102 may also reside within the environment 106.

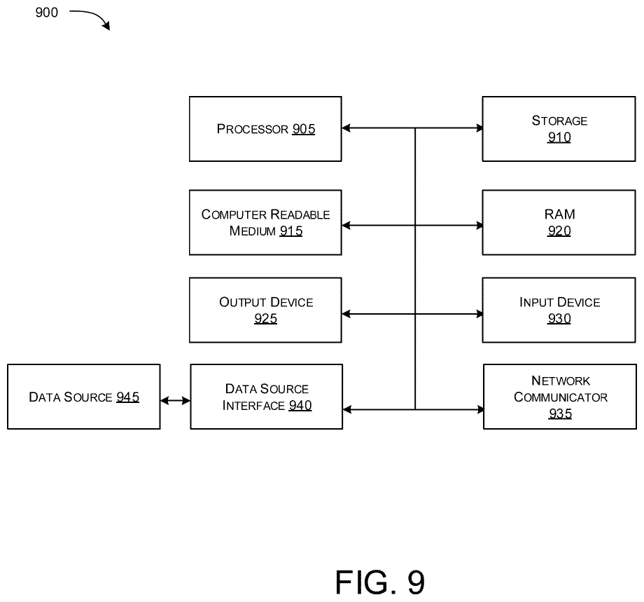

The control system 102 is further illustrated in greater detail in FIG. 9. The control system 102 may be a (personal) computer, a workstation, a virtual machine running on host hardware, a microcontroller system, or an integrated circuit. As an alternative, the control system 102 may be a real or a virtual group of computers (the technical term for a real group of computers is “cluster”, the technical term for a virtual group of computers is “cloud”).

The network 104 may include, but are not limited to, a multi-service access network (MSAN) (such as a digital subscriber line (DSL), a passive optical network (PON), or Ethernet), a wireless mesh network (such as wireless fidelity (Wi-Fi), worldwide interoperability for microwave access (WiMAX), or cellular), a hybrid fiber-coaxial (HFC) network, a multi-access edge computing (MEC) network (such as cellular, Wi-Fi, and wired connections), a software-defined wide area network (SD-WAN) (such as multiprotocol label switching (MPLS), broadband internet, and cellular networks). Further, the network 104 may include, but is not limited to, an Internet of things (IoT) network (cellular, low-power wide-area network (LPWAN), Wi-Fi, or Ethernet), a hybrid Network (such as a mixture of fiber optics, DSL, cable, and wireless connectivity options), a campus network (such as ethernet, fiber optics, wireless technologies (for example Wi-Fi)), a metropolitan area network (MAN) (such as fiber optics, ethernet, MPLS, and wireless connections), a carrier-grade network (such as fiber optics, DSL, cable, wireless (such as 4G/5G cellular networks), and satellite), a mobile network operators (MNOs) (such as 2G, 3G, 4G LTE, 5G, new radio (NR) and 6G), a power line communication (PLC) network, any other network, and a combination thereof.

The user devices 108A-N may include, but are not limited to, a smartphone, a mobile phone, a personal digital assistant, a tablet computer, a phablet computer, a wearable device, a computer, a laptop computer, an augmented/virtual reality device (AR/VR), internet of things (IoT) device, an edge device, a camera, and any other combination thereof.

It should be appreciated that the network architecture 100 and the control system(s) 102 that are depicted in FIG. 1 may be a few examples of implementations. Hence, the network architecture 100 may or may not include additional features, and some of the features described herein may be removed and/or modified without departing from the scope of the network architecture 100 outlined herein.

In some examples, the network architecture 100 may also include a private network and/or public network. The private network and/or public network may include any variations of networks. For example, the private network may be a local area network (LAN), and the public network may be a wide area network (WAN). Also, the private network and/or public network may each be a local area network (LAN), wide area network (WAN), the Internet, a cellular network, a cable network, a satellite network, or other networks that facilitate communication between the components of network architecture 100 as well as any external element or system connected to the private network and/or public network. The private network and/or public network may further include one, or any number, of the example types of networks mentioned above operating as a stand-alone network or in cooperation with each other. For example, the private network and/or public network may utilize one or more protocols of one or more clients or servers to which they are communicatively coupled. The private network and/or public network may facilitate the transmission of data according to a transmission protocol of any of the devices and/or systems in the private network and/or public network. Although each of the private network and/or public networks may be a single network, it should be appreciated that in some examples, each of the private network and/or public networks may include a plurality of interconnected networks as well.

In a preferred embodiment, the control system 102 is capable of controlling or guiding the one or more VOPs 112 using one or more Virtual Approved Pathways (VAPs). The control system 102 includes the VAP and VOP management module 101. In an example embodiment, the VAP and VOP management module 101 is configured to perform the below mentioned method steps. Alternatively, the control system 102 may cause the processor to perform the below mentioned method steps. The control system 102 is configured to determine a set of parameters associated with a VOP 112. The set of parameters may include at least one of a class, capabilities, characteristics, and requirements associated with the VOP 112. The VOP 112 is dynamically configured or guided to navigate from a source point to a destination point based on one or more tasks being requested. Each of the VOPs 112 may have different capabilities (for example what they may be able to carry or pull, how fast they may travel, and the like.) Each of the VOPs 112 may have distinctive characteristics (e.g., width, length, height dimensions, weights, and the like) impacting their ability to travel along certain VAPs, for example, based on the available space. Further, each of the VOPs 112 may have different requirements to be able to navigate and travel safely (for example floor quality, Sensor input, and the like). In an embodiment, all of the capabilities, characteristics, and requirements may be considered as properties of the VOPs 112. Further, different types of VOPs 112, with different sets of properties, would be considered different VOP “Classes”. The characteristics of a VAP and/or conditions along the VAP may change over time (for example, in the course of a day or week, according to certain patterns, or over longer periods of time, according to certain trends) which may impact to what extent the VAP is fit for use by a certain VOP to perform a certain task. The combination of the specific VOP Class, including any specific VOP properties, combined with specific environmental conditions, and combined with some time dimension, drive the decision-making by the control system 102, as they (each) guide and direct one or more VOPs 112 while they carry out their activities.

In an example embodiment, the environmental conditions along a VAP may change over time, depending on for example, the activity of other agents within the environment 106 (for example, but not limited to, forklift activity, bins or carts being placed along or even on a VAP, and the like). These environmental conditions may be observed or measured by certain sensors mounted on the VOPs 112 that are operating within the environment 106, and/or measured by certain (further) sensors 114 mounted within the environment 106.

The control system 102 is further configured to continuously obtain a first set of parameters from a plurality of data sources deployed within the environment 106 at real-time. The first set of parameters may include sensor data, one or more properties associated with a plurality of objects 110, one or more navigation objectives, a plurality of pre-defined rules associated with each object 110 within the environment 106, a plurality of priority levels, and one or more user-defined requirements or preferences.

Further, the control system 102 is configured to determine one or more navigation plans for capable VOPs 112 predicted to be available at the requested time, and dynamically configured or guided to navigate from the source point to the destination point based on the obtained first set of parameters. Each of the one or more navigation plans corresponds to at least one of a plurality of classes of VOPs 112, a plurality of environmental conditions, the plurality of pre-defined rules and the plurality of priority levels, the one or more properties associated with each object 110 within the environment 106, the one or more navigation objectives and the one or more user-defined requirements. Furthermore, the control system 102 is configured to correlate each of the determined one or more navigation plans with the one or more tasks to be performed by the one or more VOPs 112, at specific times, the at least one of the obtained first set of parameters and the determined set of parameters, using a data driven model. The data driven model may be any artificial intelligence or machine learning based models.

Further, the control system 102 is configured to determine an optimal navigation plan for the VOP 112 based on the correlation. The optimal navigation plan may include at least one Virtual Approved Pathway (VAP) connecting the source point with the destination point via a plurality of path points, dynamic properties to be configured with the VOP 112, and one or more operational rules to be followed by the VOP 112 while navigating on the at least one Virtual Approved Pathway (VAP). The one or more operational rules comprise virtual approved pathway (VAP) rules, travel restrictive rules for specific classes of VOPs, traffic rules, event-based rules, environmental condition-based rules, activity-based rules, zone-based rules, station-based rules, time-based rules, and pathway-based rules. The one or more operational rules control behaviors of the one or more VOPs 112 while navigating along respective one or more VAPs. The one or more operational rules correspond to rules which the VOP 112 is required to comply with, based on the rules which are applicable to the VOP 112 along the optimal trajectory navigated by the VOP 112 while performing the task.

In determining the optimal navigation plan for the VOP 112 based on the correlation, the control system 102 is configured to retrieve one or more Virtual Approved Pathways (VAPs) within the environment 106 from at least one of the one or more VOPs 112 and the plurality of objects 110, using real time location systems (RTLS) and one or more sensors 114. In an embodiment, the VAPs may be either pre-stored in a database or pre-recorded during an initial system set-up or may be hand-drawn using the GUI screen by one or more users. A detailed explanation of the same has been provided in the paragraphs below. In an alternate embodiment, the VAPs may be obtained at real-time from one or more VOPs 112 existing within the environment 106. Further, the control system 102 is configured to determine one or more zones and stations existing within the environment 106 based on the first set of parameters. The one or more zones may include one of a free roaming zone, a no-go zone, and an intersection zone, or the like. The VOP 112 is directed or guided to choose a desired trajectory when in the free-roaming zone until the VOP 112 exits the free roam zone. The VOP 112 is configured or guided to restrict navigating via the no-go zone. The VOP 112 is configured or guided to automatically modify its behavior, such as performing a temporary halt and then traveling at reduced speed, while transversing the intersection zone.

Further, the control system 102 is configured to determine one or more best possible trajectories for navigation of the VOP 112 based on the obtained one or more VAPs and the one or more zones and stations. Each trajectory comprises a plurality of path points, and where each trajectory is guided by one or more waypoints.

Furthermore, the control system 102 may identify an optimal trajectory among the determined one or more best possible trajectories for the VOP 112 based on one of the plurality of classes of VOPs 112, the plurality of environmental conditions, the plurality of pre-defined rules and the plurality of priority levels, the one or more properties associated with each object within the environment 106, the one or more navigation objectives and the one or more user-defined requirements. In an example embodiment, this “trajectory charting” (or “travel route planning”) is typically performed by the control system 102, taking into account all the available (and ideally up-to-date) information, such as sensor data, VAP properties and/or VOP properties 112 and/or Load Properties and/or Cart Properties and/or VOPL Properties 116 and/or VOPC Properties 118, the combination of certain VAP and/or VOP 112 and/or Load and/or Cart and/or VOPL 116 and/or VOPC 118 Properties (also referred to as “property matching”), and any (VAP) rules and VAP priority levels involved. Based on all the best available (ideally accurate and up to date) information, the control system 102 may evaluate a range of options to chart an optimal Trajectory, that is for example feasible, safe, effective, and/or efficient (for example selecting the shortest or quickest trajectory), respecting any combination of rules and/or objectives as set by an administrator. For example, if the control system 102 is informed about a congestion situation or blockage along some section of a VAP, then the control system 102 may chart a Trajectory that avoids that VAP section, while still trying to achieve the set objectives as best as possible. The objectives may be defined as user-defined objectives to be applied to one or more tasks to be performed by one or more VOPs 112 at certain times (or during certain time windows) such as performing such task “as soon as possible”, and/or “as quickly as possible”, and/or “as safely as possible”, and the like. Depending on changing circumstances, i.e., changing combinations of all the available information, different trajectories may be charted at various times. At any time while the VOP 112 is traveling, or getting ready to travel, along a Planned Trajectory, the control system 102 involved may change the remaining (“incomplete” or “untraveled”) part of a previously planned Trajectory, to chart a new trajectory, based on real-time changing circumstances in the environment 106. This will typically cause the control system 102 to develop a new optimal navigation plan, taking into account e.g., all the Rules applicable along the new trajectory, and incorporating those rules into the navigation plan as operational rules to be adhered to, along the travel route, by the VOP 112.

In case a VOP 112, while executing a planned Trajectory along existing VAPs, encounters a “Free Roam Zone”, then, anywhere within such Free Roam Zone, the VOP 112 is allowed to choose any travel trajectory it deems effective or otherwise desirable (e.g. based on the VOPs 112 local planning abilities) until it exits such Free Roam Zone and continues along the planned Trajectory, respecting the existing VAPs. In case a certain VAP Section would run through a “No Go Zone”, then the control system 102 may avoid creating planned trajectories that require that particular VAP Section for the VOP 112 to reach its destination.

In an example embodiment, the control system 102 is configured to evaluate one or more possible combinations between available VOPs 112 and/or available VAPs and/or possible trajectories within the environment 106, to decide which VOP 112 is best positioned to perform a task. Further, the control system 102 is configured to match existing properties and/or rules associated with the available VAPs to properties and/or rules associated with the available VOP 112 and/or properties and/or rules associated with one of the tasks to be performed, and/or the one or more loads involved, and/or the one or more carts involved, and/or the environmental conditions existing and/or predicted at the time when the task is to be performed. Further, the control system 102 is configured to determine the optimal trajectory for a best suited VOP 112 to perform the task based on the matching.

Furthermore, the control system 102 is configured to determine the one or more operational rules to be followed by the VOP 112 based on the identified optimal trajectory. Further, the control system 102 is configured to determine the dynamic properties to be configured with the VOP 112 based on the determined one or more operational rules. Additionally, the control system 102 is configured to define the at least one Virtual Approved Pathway (VAP) connecting the source point with the destination point via the plurality of path points. In an example embodiment, in defining the at least one Virtual Approved Pathway (VAP) connecting the source point with the destination point via the plurality of path points, the control system 102 is configured to identify the plurality of path points between the source point and the destination point using the Real-Time Location System (RTLS). Further, the control system 102 is configured to generate a route from the source point to the destination point. The route may include the identified plurality of path points.

Also, the control system 102 is configured to define the at least one priority level for the VOP 112 based on the defined VAP, the one or more operational rules, and the dynamic properties to be configured with the VOP 112. Specifically, the control system 102 may choose the optimal AV/VOP 112 from all the different VOPs 112 in the environment 106 that may be available (or be predicted to be available) at the right time (or within the right time window) when needed to perform a certain task, and that are capable of performing such task, based on their properties matching some or all of the task properties or the like. Further, the control system 102 determines the best route by taking into account pre-defined priority levels among the available (and relevant) VAPs. However, the VOP 112 may obtain its own priority level, based on the defined VAP and other considerations. For example, there could be multiple VOPs 112 present in the environment 106, that are all capable of performing a certain task, and the control system 102 may evaluate all the possible combinations between the available VOPs 112, the available VAPs, and the all the possible trajectories, to decide which VOP 112 is best positioned to perform the task. For example, the control system 102 calculates all the different options, across all the available and capable VOPs 112, for a certain Task to be performed, scoring and prioritizing each option, to ultimately select the VOP 112 and determine an optimal trajectory for that VOP 112 to perform the given task, according to all the objectives and within all the applicable Rules.
In an example embodiment, the control system 102 may associate a certain priority (or “priority level”) as a property to each VAP, such that the control system 102 may use that property to prioritize certain VAPs (or VAP Sections) over others, when determining one or more possible trajectories for certain VOPs 112 to perform certain tasks. Further, the control system 102 may also determine multiple VOPs 112 that may be available and capable of performing a certain Task, possibly giving those VOPs 112 a priority level, such that the highest-priority VOP 112 typically gets a certain task assigned, while the one or more lower-priority VOPs 112 may function as backup VOPs 112 in case the priority VOP 112 runs into some kind of problem, or may be called upon to perform some higher-priority task or the like. Specifically, the control system 102 may maintain one or more “backup” VOPs 112, each ranked according to their determined priority levels, in case the originally selected VOP 112 would become unable to perform the assigned Task for any reason. In case an originally selected VOP would become unavailable to perform an assigned Task and depending on the circumstances (e.g., time passed since the assignment), the control system 102 may also unassign the previously selected backup VOPs 112 and reinitiate the planning effort from scratch to determine a new optimal navigation plan, including, selecting a new VOP 112, to perform the Task.

In an example embodiment, the VAPs are virtual representations of approved routes within an environment 106, defined by a set of coordinates within a defined coordinate system. These routes act as a framework for the VOP 112 movement while allowing for adaptability based on specific VOP 112 capabilities and environmental conditions. The VAPs are associated with various properties and rules (“VAP Properties” and “VAP Rules”) that influence VOP's actions and/or behavior while navigating along the VAPs. These properties and rules may be adjusted to specific VOP 112 types or adapted dynamically based on environmental conditions. This allows for differentiated control over different VOPs 112, or adjustments based on factors such as for example, but not limited to, load weight, traffic congestion, or time of day.

The control system 102 may store the VAPs, including both their Routes and associated properties and rules. This control system 102 may be located on-board an VOP 112 itself, installed and running on a user device e.g., carried by a user, maintained within the environment 106 (local server), or hosted remotely in a private or public cloud environment. At times, various parts of the routes and/or properties related to certain VAPs, or VAP sections may be stored in different computer systems at the same time (for backup and other purposes). The VAPs may inform the VOP 112 about areas of the environment 106 that may be accessed and navigated by the VOP 112, and then be used by the VOP 112 to (ideally safely, effectively, and efficiently) navigate through the environment 106 (at certain times, in certain ways, and/or depending on certain circumstances, according to certain properties and rules involved). The VAPs are defined by their routes, i.e., a set of coordinates, according to a certain coordinate system. The VAPs hold various VAP properties and VAP rules, which may influence or control the behaviors of certain VOPs 112 while they are navigating along the VAPs. Certain VAP Properties and/or VAP rules may only apply to certain VOPs 112 but not to others. Certain VAP properties and/or VAP rules may apply differently to certain VOPs 112 as compared to others. Certain VAP Properties and/or VAP Rules may be different depending on certain environmental conditions. Certain VAP Properties and/or VAP rules may change/evolve over time.

The VAPs may evolve over time as far as their routes and/or properties are concerned, e.g. depending on the time of day and/or environmental conditions. The VAPs may have different VAP priority levels, as assigned and/or stored by the control system 102, which may influence or control the behavior of VOPs 112 traveling along the VAPs within the environment 106. For example, the VOP 112 may choose or be made to select the highest-priority VAP when planning or performing its travel. Further, the VAP priority levels may change over time, for example in view of the environmental conditions. Further, certain VAPs may overlap or coincide partially or completely with other VAPs, as far as their route is concerned, while possibly carrying different properties and/or rules, in which case a VOP 112 may choose or be made to switch from one VAP to another, adopting or adhering to the other VAP's Properties and Rules in the process.

In an embodiment, the VAP may be, in whole or in part, parallel to other VAPs or VAP sections, possibly created by the control system 102, on a temporary basis to help the VOP 112 avoid an obstacle, whereby the distance between the parallel VAPs or VAP sections may be defined and adjusted dynamically by the control system 102. Further, the VAP may be changed dynamically, and possibly just-in-time, by the control system 102, as far as the routes or properties or rules are concerned. For example, depending on changing environmental conditions, the control system 102 may help the VOP 112 navigate safely, effectively, and efficiently, while for example, overcoming certain obstacles along the way.

In an example embodiment, the VAPs help to restrict where specific VOPs 112 or classes of VOPs 112 are allowed to travel while navigating around a certain environment 106 to perform certain tasks and/or achieve certain objectives. The restrictions may include for example, specifying which physical paths a certain (class of) VOP 112 is allowed to take within the environment 106, under certain circumstances. The restrictions may include, for example, making sure the paths are feasible overall, for the certain (class of) VOP 112, taking into account, for example, the location of walls, doors, aisleways, equipment, and the like, as well as environmental conditions, such as floor conditions, and the like. The restrictions may further include making sure the paths (including, required turns) are feasible by the specific type or class of VOP 112 or VOPC 118 or VOPL 116 (respecting for example, but not limited to, turning radius limitations, weight restrictions, height restrictions, and the like). Further, the restrictions may include possibly taking into account data collected from certain sensors mounted on the VOP 112, for which a trajectory is being planned, and/or from sensors mounted on any other VOPs 112 operating in the same environment 106, and/or from any sensors 114 otherwise present in the environment 106. The data collected may be used to determine whether or not a certain trajectory is (for example) feasible, safe, effective, and/or efficient, or anticipated to be (for example) feasible, safe, effective, and/or efficient for the intended activity and/or objective by one or more specific VOPs 112 at a certain current or future time, depending on possibly dynamic circumstances (e.g. actual or expected or predicted congestion or obstacles in certain areas of the environment 106. Further, in an embodiment, the data collected may be analyzed to detect trends and patterns over time, to learn which pathways to prioritize for VOPs 112 to be able to perform their activities in the best possible manner.

In an embodiment, the VAPs help to direct how specific classes of VOPs 112 are allowed to travel while navigating around their environment 106 to perform certain tasks and/or achieve certain objectives, by defining certain VAP properties and VAP rules, and matching them with certain VOP properties (“Property Matching”). Certain properties may include imposing certain restrictions, along the trajectories planned along the available VAPs. The certain restrictions may include allowing directionality (possibly further restricted based on certain circumstances, e.g. whether a VOP 112 is carrying a Load, or pulling/pushing a Cart, or not), and height restrictions (e.g. certain VOPs 112 fit under certain racks or conveyors, while others VOPs 112 may not or; a VOP 112 may fit and be able to travel under a certain obstacle while empty, but not while carrying a Load). Further, the certain VOP 112 properties may include imposing certain traffic rules, along the trajectories planned along the available VAPs. The traffic rules may include speed restrictions (for example target/min/max speed a VOP 112 is allowed to travel at possibly depending on whether or not a VOP 112 is carrying a certain kind of Load or pushing/pulling a certain kind of Cart, possibly depending on dynamic environmental circumstances). The traffic rules may include distance restrictions (for example target/min/max distance a VOP 112 should maintain from other VOPs or Objects). The traffic rules may further include “drive center” vs. “drive to the left” vs. “drive to the right” of the VAPs, at certain defined distances. Further, the traffic rules may include right-of-way or other priority rules, for example when multiple VOPs meet at an intersection. All of these traffic rules may be defined (configured) automatically, when drawing, recording, or otherwise defining a new VAP, by applying the default VAP rules, making it very quick and easy to set up and control VOPs 112 in an environment 106.

In an example embodiment, certain VOP properties may include imposing certain preferences or priorities, such as, for example, but not limited to static priorities (for example selecting wider paths over narrower paths) or dynamic priorities (for example selecting less congested or less cluttered paths over more congested or more cluttered paths). Further, certain VOP properties may include guiding VOPs along the safest and/or quickest and/or shortest paths, depending on certain circumstances and decision-rules, for example, matching VOP Properties with VAP Properties (for example, VOP 112 width versus travel path width, turning radius required versus available, floor quality required versus available, and the like). Further, the decision-rules may include determining whether the VOP 112 is carrying a (certain kind of) Load, pushing or pulling a (certain kind of) Cart, or traveling empty, or the like.

In an example embodiment, the destination point may be set as a moving object's position. For example, any moving object within the environment 106 may be the destination point. Alternatively, any static object or fixed location may also be considered as a destination point at times. In case of a moving object being the destination point, the control system 102 may determine if the moving object continues to move. In such a case, the control system 102 may chart a trajectory that allows the VOP 112 to reach the set destination position (while respecting the rules and objectives), including, continuing to adjust the destination position, and re-charting planned trajectories to reach the updated destination position, based on the moving object's changing position, as detected by one or more sensors 114 carried by the VOP 112 and/or RTLS tag 120 present in the environment 106. Further, the control system 102 may also set an anticipated position of the moving object as the destination position for the VOP 112 based on observing and analyzing the location and movement of the moving object, possibly using machine learning or artificial intelligence methods.

In an example embodiment, the VOP 112 may have the ability to move as close as possible towards the moving object's position (which is the destination position), while remaining on the VAP. The VOP 112 may further maintain the closest possible distance to the moving object, when the moving object may continue to change its location, while the VOP 112 continues to remain on the available VAPs.

In an example embodiment, the control system 102 may create a new, not previously defined VAP (also called a “Temporary VAP” or “Ad Hoc VAP”), if or when allowed, to enable the VOP 112 to reach a certain destination that is located too far from the existing VAPs within the environment 106. For example: when Carts are being stored in a wide-open warehouse area, the control system 102 may define a required VAP, dynamically, for the VOP 112 to be able to reach a certain Cart, based on the specific Cart location and environmental conditions at that time.

Additionally, the control system 102 is configured to navigate the VOP 112 within the environment 106 based on the determined optimal navigation plan, including an optimal trajectory along the available and matching Virtual Approved Pathways (VAPs). The VOPs 112 are guided by one or more waypoints, acting as path indicators along the planned trajectory. The control system 102 is configured to determine whether the optimal navigation plan is to be updated based on the plurality of environmental conditions, a current position of the destination point, a predicted position of the destination point, possible movements of the destination point, and the first set of parameters. In determining whether the optimal navigation plan is to be updated, the control system 102 is configured to continuously monitor the current location of the VOP 112 relative to the identified optimal trajectory to determine whether the VOP 112 deviates greater than a threshold distance value from the optimal trajectory along the Virtual Approved Pathways (VAPs). Further, the control system 102 is configured to determine the plurality of environmental conditions, the current position of the destination point, the predicted position of the destination point, and the possible movements of the destination point. The plurality of environmental conditions is determined using one or more sensors 114 present within the environment 106. The one or more sensors 114 may include sensors associated with the one or more VOPs 112. The current position of the destination point is determined using at least one of a fixed location coordinate (in case of, for example, a fixed station), a Real Time Locating Systems (RTLS) with one or more RTLS tags 120 co-located with the destination point (for example, in case the destination point would be the location of a moving object), certain sensors (such as cameras) present in the environment 106, certain sensors associated with the VOP 112 being directed to the destination point, and certain sensors associated with other VOPs 112 currently deployed in the environment 106.

Further, the control system 102 is configured to determine one or more possible collision events on the Virtual Approved Pathways (VAPs) based on the determined plurality of the collection of all the navigation plans and associated trajectories being planned or performed for or by all the VOPs operating within the environment 106, environmental conditions, and the first set of parameters obtained at real-time. Specifically, the control system 102, while directing or guiding a VOP 112 along planned trajectories, may include identifying and avoiding possible collision with fixed or mobile obstacles, including other VOPs 112. The control system 102 continuously evaluates and replans the planned trajectories, and associated navigation plans, for all VOPs 112 active in the environment 106, to avoid possible collision, while enabling the VOPs 112 to continue to travel towards their intended destination points, such as stations or targets, in line with all the applicable rules and/or objectives, and based on all available information known by the control system 102, based on the data provided by one or more sensors 114 carried by the VOP 112 itself, and/or any other VOPs 112 operating in the environment 106, and/or any sensors otherwise present in the environment 106).

Further, the control system 102 may be configured to create one of a temporary VAP in addition to the current VAP, an updated VAP, and a new VAP for the VOP 112, based on the current position and planned trajectory of the VOP 112, the determined one or more possible collision events, the plurality of environmental conditions, the current position of the destination point, the predicted position of the destination point, and the possible movements of the destination point. The temporary VAP hereby inherits certain properties and rules from the at least one VAP along the original planned trajectory. Specifically, the control system 102 may possibly define a temporary VAP that runs besides, and possibly parallel to, the existing VAP (also called the “original VAP”), allowing the VOP 112 to safely pass an obstacle that is positioned on the existing VAP, until the VOP 112 may safely return to the original planned trajectory, on the original VAP, and continue its travel. The control system 102 may create such temporary VAP while respecting any relevant VAP Rules associated with the existing (“original”) VAP, such as the maximum distance a VOP 112 is allowed to diverge or deviate from the existing VAP in order to avoid an obstacle. In an embodiment, a temporary VAP may inherit certain VAP properties and rules from the existing VAP, such as the maximum speed a VOP 112 is allowed to travel at while on the temporary VAP. Such speed may match the defined travel speed for the existing VAP, or be different, possibly expressed as a percentage of the travel speed on the existing or “original” VAP.

In case the control system 102 is unable to provide a temporary VAP that allows the VOP 112 to avoid an Obstacle, while respecting all relevant VAP rules, the control system 102 may halt the VOP 112 in place for a defined period of time, until the obstacle becomes resolved, and/or the control system 102 may create a new planned trajectory to direct the VOP 112 along a different (set of) pathway(s) (or path sections) towards its target or destination station.

In an example embodiment, the control system 102 is configured to generate visual representations of the environment 106 at real time using at least one of RTLS tags 120 and one or more sensors 114 deployed within the environment 106. The visual representations may include a plurality of virtual elements corresponding to each of the plurality of objects 110 deployed in the environment 106 and the visual representations may include a map of the environment 106. The visual representations represent an entire range of “rules” that the one or more VOPs 112 operating within the environment 106 need to abide by. The control system 102 is further configured to determine the properties and movements associated with each of the plurality of virtual elements depicted in the generated visual representations. The virtual elements are configured to perform one of inherit and overrule one of properties and rules of the other virtual elements based on the plurality of environmental conditions and based on the absolute location of the virtual element within the environment 106 and/or based on a relative position of the virtual element relative to one or more other virtual elements. For example, depending on the circumstances, zones, pathways, stations, and even other VOPs 112, the VOPs 112 may inherit or overrule each other's properties and/or rules. For example, certain zones may have rules that take priority over (“overrule”) certain rules associated with certain pathways, pathway sections, or stations that fall within those zones. For example, all path sections within a certain zone may be off-limits to a certain class of the VOPs 112. In a preferred example, the intersection zone may be a zone where the VOPs 112 have to slow down, temporarily pause before entering, and then use certain light and sound signals while traversing that zone. Hence, when placing an intersection zone around an intersection of VAPs, the VAP sections that lie within that intersection zone will adopt the intersection zone's rules, making any VOP 112 traveling along those VAP sections behave in the desired manner. Other examples may include, but are not limited to, free roam zone, no go zone, slow down zone, and the like.

Further, the control system 102 is configured to determine the plurality of rules associated with each of the plurality of virtual elements depicted in the generated visual representation. Also, the control system 102 is configured to compare the determined properties, the movements, and the plurality of rules associated with the virtual elements with corresponding pre-defined properties, pre-defined movements and pre-defined rules stored in a database. For example, the VOP 112 width is compared with the travel path width, turning radius required is compared with the available radius, the floor quality required is compared with the available floor quality, and the like. Further, the control system 102 is configured to determine whether the optimal navigation plan is to be updated based on the comparison.

In some preferred embodiment, the VOP 112 is able to create at least one Simultaneous Locating and Mapping (SLAM) map of the environment 106 while navigating along the VAP using the RTLS tags 120. Alternatively, the VOPs 112 may use any other technology or method for creating maps or floor plans of the environment 106. Further, the VOPs 112 are configured to transmit the created SLAM map to other VOPs 112 within the environment 106. In an embodiment, the VOP 112 may transmit the SLAM map to other computing devices 124 or to the control system 102.

In conventional systems, current Autonomous Vehicles (AVs) 112A may require a map of the environment 106 in order to be able to navigate within that environment 106. Such a map is created using a method typically referred to as “Simultaneous Localization and Mapping” (SLAM). These SLAM maps may be created by a human who steers an VOP 112 around the environment 106, using some type of remote control, while the VOP 112 maps the environment 106, typically collecting data using one or more LiDAR sensors or possibly using vision cameras or other sensors that are able to map certain aspects and features of the environment 106 in such way that an VOP 112 should be able to recognize certain environmental features at some later time, allowing the VOP to determine its position within the environment 106. Instead of a human remote-controlling an VOP 112, around an environment 106 to be mapped, an VOP 112 may also follow a human around an environment 106, while mapping the environment 106. And, instead of a human steering an VOP 112 around an environment 106 to map that environment 106, one or more VOPs 112 may also be allowed to explore the environment 106 in an autonomous manner, while mapping the environment 106. All these methods are state of the art. The present control system 102 does not require an VOP 112 to move around an entire environment 106 in some self-directed manner to create a map of the environment 106. Further, the present control system 102 does not require a human to direct an VOP 112 around the environment 106 either. Instead, the present control system 102 may create one or more VAPs, for example, by drawing them onto an existing map of the environment 106, or by recording them with an RTLS Tag 120 after which an VOP 112 follows the established VAP or VAPs to create a SLAM map of the environment 106, by travelling only around the established VAP or VAPs and nowhere else. This process of mapping is much easier, quicker, and more controlled.

Once one or more VAPs have been created within the environment 106, a VOP 112 may travel along those VAPs, while remaining on the VAPs and respecting all the applicable rules and properties, in order to map out the environment 106 using LiDAR sensors. The map or maps created in such way, may then be used for the VOP 112 and/or any other VOPs 112 within the same environment 106, which may share the map information through the control system 102. The VOPs 112 are able to enhance their navigational abilities, by combining SLAM (“Simultaneous Locating and Mapping”) methods with RTLS-based localization and navigation methods.

In some embodiments, the one or more user devices 108A-N may generate an augmented-reality (AR) based representation as a visual representation of the physical environment 106. The AR-based representation may include the virtual elements emulating some or all the plurality of objects 110 within the physical environment 106, the one or more VAPs, destinations, trajectories, current and historical locations of the virtual elements, properties and rules associated with the virtual elements and the like. Further, the one or more user devices 108A-N are configured to enable user interactions with the virtual elements via the generated AR-based representation. The user interactions may include, for example, recalling some or all of the locations and movements of static and/or dynamic elements, either in real-time, or at specific past times or periods in time. The static elements may correspond to, for example, the one or more VAPs, one or more zones, and one or more stations defined within the environment 106, as well as, for example, respective rules and properties associated with each of the VAPs, zones, and stations. The dynamic elements may correspond to, for example, the one or more destinations, the plurality of environmental conditions, tasks, destination points, targets, temporary VAPs, trajectories, and travel intent. The visualizations may include one of replaying the past locations of the virtual elements at previous points in time, replaying movements of the virtual elements during past periods in time, future locations of the virtual elements predicted to be at future periods in time and the like. Furthermore, user interactions may include accessing and modifying the properties and rules associated with the virtual elements and interacting with, including possibly modifying, the virtual elements on the AR-based representation. In an alternate embodiment, the visual representations may also include any other form of visual representations such as Virtual-Reality (VR), Mixed-Reality (MR), Enhanced Reality (ER), or the like.

In generating the augmented-reality (AR) based representation as one of the visual representations of the physical environment 106, the one or more user devices 108A-N are configured to project the AR-based representation onto an AR capable device associated with a user. The AR-based representation may include the virtual elements, as well as some or all of the possible properties and rules associated with the virtual elements, superimposed in real-time onto a graphical user interface screen of an AR capable device. Alternatively, the AR-based representation may include the virtual elements, as well as some or all of the possible properties and rules associated with the virtual elements, superimposed in real-time onto a graphical user interface screen of the one or more user devices 108A-N or any other device. For example, the AR capable device may include, but is not limited to, mobile devices, specialized AR glasses, AR headsets, and the like.

In some embodiments, some or all the virtual elements, and possibly some or all of the possible properties and/or rules associated with those virtual elements are displayed to an operator or administrator, in Augmented Reality (AR). Further, virtual information associated with certain virtual elements and their possible properties and/or rules, is hereby projected (or “overlaid” or “superimposed”), in real-time, onto the user interface of the (“physical” or “real-world”) environment 106, using a (capable) AR device. Using AR, the control system 102 may show, in a user-friendly manner, where exactly in the (“physical”) environment 106 certain “static” virtual elements, such as VAPs or VAP sections, are located. Furthermore, using AR, the control system 102 may also show, in a user-friendly manner—where exactly in the (“physical”) environment 106 certain “dynamic” virtual elements, such as, for example, certain destinations, are located at some “real-time” point in time (“live”). Further, if the required information was captured and stored, the control system 102 may be able to “replay” where certain Virtual Elements were located at some previous point in time, or “replay” how certain Virtual Elements moved around or traveled during some previous period in time, or show where certain Virtual Elements are expected or predicted to be at some future point in time. For example showing part or all of the already traveled and/or still planned trajectories of one or more VOPs 112, as they operate within and travel through the environment 106.

Furthermore, using an AR Device, a user may also be able to access (for example: request or look up) and possibly change some or all of the specific properties and/or rules associated with certain virtual elements.

Furthermore, using AR Devices, multiple users, possibly at the same time and in a collaborative manner, may interact with and manipulate some of the Virtual Elements. For example, a user, or multiple users working collaboratively, may view and change the routes of one or more VAPs by manipulating one or more of the path points that define the specific routes of the VAPs. Or, a user, or multiple users working collaboratively, may change the location of one or more stations by moving the virtual representations of such station or stations in Augmented Reality, thereby impacting the location coordinates of the affected station or stations as stored in the control system 102.

In an embodiment, the control system 102 is configured to identify potential conflicts between one or more Virtual Approved Pathways (VAPs) and the capabilities of a specific class of VOP 112, based on the properties of that class of VOP 112. Further, the control system 102 is configured to visually represent the identified conflicts as graphical representations on a graphical user interface and/or in Augmented Reality. Further, the control system 102 is configured to generate one or more suggested solutions for rectification of the identified potential conflicts. Furthermore, the control system 102 is configured to receive approval and possibly final selection or decision from a user of the generated one or more solutions.

Moreover, the control system 102 is configured to update at least a portion of the optimal navigation plan based on the plurality of environmental conditions and the first set of parameters obtained in real-time. In updating at least, the portion of the optimal navigation plan, the control system 102 is configured to modify some or all the speed, direction, and a rate of travel of the VOP 112. Further, the control system 102 is configured to halt the movement of the VOP 112 in its current position until the determined one or more possible collision events are resolved. For example, in case the control system 102 is unable to provide a temporary VAP that allows the VOP 112 to avoid an Obstacle, while respecting all relevant VAP Rules, the control system 102 may halt the VOP 112 in place for a defined period of time, until the obstacle becomes resolved, and/or the control system 102 may create a new planned trajectory to direct the VOP 112 along a different (set of) pathway(s) or path sections towards its target or destination station.

When (“pre”) recording one or more Virtual Approved Pathways (VAPs) using one of RTLS Tags 120 and user-driven inputs, the control system 102 is configured to automatically tune the recorded pathways. The (auto-)tuning may include one or more of automatically correcting, automatically smoothening, automatically straightening, automatically aligning, and automatically connecting the one or more pathways, before storing the newly created pathways as VAPs. Further, the control system 102 is configured to display certain parts of the one or more pathways (or VAPs) as visual highlights when those certain parts of pathways (or VAPs) are identified to be unsuitable.

In an example embodiment, the control system 102 is configured to record one or more pathways or pathway sections, by navigating a VOP 112 within the environment 106, either autonomously or remote-controlled by a human user, while recording the travel path of the VOP 112, for example using one or more RTLS tags 120 co-located with (e.g., mounted on or carried by) the VOP 112. One or more of recorded pathways may be accepted or rejected by the control system 102 after for example, but not limited to, auto-tuning the pathways.

In an example embodiment, the control system 102 may record one or more pathways or pathway sections, while a VOP 112 is walking, or otherwise moving around, the environment 106, while carrying an RTLS Tag 120. In case the RTLS Tag 120 has a button, then the control system 102 may start and/or finish the recording of a pathway or pathway section when the tag's button is pushed in a certain way (e.g. short press vs. long press, or single-press vs. double-press). Alternatively, the recording of a pathway or pathway section may also be started and/or finished when the VOP 112 reaches certain predetermined zones and/or stations. Alternatively, the recording of a pathway or pathway section may also be started and/or finished by clicking or tapping the right button or buttons in a software application on, for example, a laptop, or a mobile application (“App”) on a smart phone or tablet computer, and the like. In these ways, the control system 102 is able to define an entire pathway or set of pathways in the environment 106, simply by walking around and recording the traveled route(s). As RTLS Tags 120 typically provide location estimates that exhibit a certain amount of variation (“jittery data”), and as people (e.g. administrators) may not always walk or otherwise travel in perfect straight lines or make perfect (for example 90-degree) turns, and as people (e.g. administrators) may not always start or finish recording consecutive pathways or pathway sections in the exact right locations, a computer program in the control system 102 may automatically smoothen, straighten, align and/or connect the recorded pathways or pathway sections, before submitting those auto-tuned pathways to a user for approval, at which point they become Virtual Approved Pathways. In case of recording a pathway using an RTLS Tag 120, and in case of drawing a pathway, by hand, in/on a graphical user interface, the control system 102 may modify the pathway route automatically, based on, for example, certain properties of certain VOPs 112 or VOP Classes.

In an example embodiment, defining the shape of a pathway, using a graphical user interface (GUI) on a computer, may be performed, either by defining individual path points, for example by clicking with a mouse or tapping with a finger, or by drawing a pathway, with mouse or finger. For example, while drawing, the control system 102 may identify or select relevant path points along the human-defined pathway and store these path points as a representation of the pathway. Once the pathway has been drawn, either the administrator or the control system 102 may continue to manually or automatically adjust the pathways' shape based upon required needs, by selecting certain individual path points along the pathway, using a computer mouse on a computer, or using a finger on a smart phone or tablet, and deleting them or dragging them into a different location. Further, the control system 102 may possibly add additional path points to further modify (or manipulate) the shape of the pathway. Once the pathway has been drawn, either the Administrator or the control system 102 may continue to adjust the pathway's shape to required needs, by selecting certain sections along the pathway, and changing the shape of the path section, by dragging certain points of the section. Therefore, the control system 102 helps to make the pathway smooth and/or straight and connected, interpreting the preferences of the administrator within the known context of the environment 106 (including for example, the available map or floor plan of the environment 106).

The control system 102 may auto-smoothen, auto-straightens, auto-align, and/or auto-connect pathways that were hand-drawn or recorded using an RTLS Tag 120. The control system 102 may further highlight parts of a pathway or VAP that are not feasible for specific classes of VOPs 112 (for example, in case of a too sharp turn) and/or under certain circumstances (for example, where meant to carry wide loads). The circumstances may include until all issues have been corrected, and until auto-suggested corrections (i.e. as suggested by the control system 102) are accepted by a user (typically an Administrator). Further, the control system 102 may auto-correct the recorded or hand-drawn pathways to create feasible pathways for the specific classes of VOPs 112 that will be operating in the environment 106. For example, the control system 102 may possibly create different pathways for different classes of VOPs 112, based on their physical characteristics, such as particular steering mechanism(s) used (for example, skid steering versus front wheel steering such as Ackermann steering, and the like).

In an example embodiment, in updating the optimal navigation plan, the control system 102 is configured to modify at least one of a route of the VAP and the properties associated with the VAP in real-time based on the determined plurality of environmental conditions. Further, the control system 102 is configured to modify the priority level assigned to the VAP based on the determined plurality of environmental conditions.

In updating some portion or full portion of the optimal navigation plan, the control system 102 is configured to generate one or more suggestions to correct the current VAP and/or the properties and/or the rules of the current VAP (or the route).

In an embodiment, the control system 102 is configured to simulate the determined optimal navigation plan in a virtual environment for validating the determined optimal navigation plan. The virtual environment emulates a physical environment 106. Further, the control system 102 is configured to deploy the determined optimal navigation plan in the physical environment 106 based on results of simulation. The results of simulation may indicate whether the optimal navigation plan is accurate for the VOP 112 selected or not. For example, the control system 102 creates a virtual environment that mimics the physical environment 106. Here, the control system 102 tests the optimal navigation plan to see if it works as expected. The virtual environment may be a computer-generated world that replicates the real world, including things like roads, buildings, walls, doors, aisleways, and obstacles. The virtual environment imitates the important features of the real world that could affect navigation by the VOPs 112. If the route works well in the virtual environment, the control system 102 sends the optimal navigation plan to a VOP 112, and the VOP 112 executes it in the real world. In an example, the control system 102 may leverage a digital twin to create and evaluate navigation plans in a virtual environment. This digital twin is a digital replica of the actual physical environment 106 and designed to mirror its real-world counterpart.

For example, the virtual environment might include simulated cars or forklifts, pedestrians, and traffic lights. The control system 102 may test the planned route in this virtual environment to see if the VOP 112 may run into certain problems or complete the task on time. Instead of the virtual environment, the control system 102 may also use historical data and machine learning to predict potential problems along a possible route. The control system 102 may also use real-time sensors on the VOPs 112 to gather information about their surroundings and adjust the planned trajectories on the fly.

In an example embodiment, the control system 102 is further configured to control the VOP 112 based on the updated optimal navigation plan, the plurality of environmental conditions and the first set of parameters obtained in real-time.

In an embodiment, the control system 102 is further configured to identify a current state of a VAP or VAP Section based on the plurality of environmental conditions and the first set of parameters obtained in real-time. The current state of a VAP Section may include temporarily unavailable. Furthermore, the control system 102 is configured to actively launch one or more VOPs 112 to the VAP section and to specific sections within the environment 106 for validating the identified current state, re-determine the plurality of environmental conditions and re-transmit the first set of parameters at real-time. The one or more VOPs 112 that are determined to be available and capable of performing the task, navigate and reach the destination point. In an example embodiment, the control system 102 may define or redefine planned trajectories based on data provided by the sensors that are carried by (e.g. “mounted on”) the VOP 112 being directed by the control system 102, and/or Sensors carried by any other VOPs 112 operating in the same environment 106, and/or sensors 114 present (“mounted”) in the environment 106 itself (i.e. not mounted on or carried by a VOP 112). The planned trajectories, as well as the underlying VAPs and VAP priorities, may be dynamically created and adjusted by the control system 102, based on the collective sensor data provided by one or more, and possibly all, VOPs 112 operating in the same environment 106. For example, when the VOP 112 identifies a congestion or obstruction along a certain VAP section, the control system 102 may identify that VAP section as temporarily “unavailable”, either for a certain period of time, or until the control system 102 decides to send an available VOP 112 out to that same path section to investigate if the congestion or obstruction has been resolved yet, after which the VAP section may be switched back to “available”. Specifically, the control system 102 may actively send one or more VOPs 112 to certain parts of the environment 106, to observe and possibly measure certain environmental conditions, and inform its further decision-making based on those observations/measurements.

In an example embodiment, the control system 102 is further configured to detect patterns, behaviors, and trends associated with the obtained first set of parameters, the plurality of environmental conditions, and one or more possible collision events. Further, the control system 102 is configured to train a dataset based on the detected patterns, behaviors and trends associated with the obtained first set of parameters, the plurality of environmental conditions, and the one or more possible collision events. Additionally, the control system 102 is configured to tune or adjust the dynamic properties and the one or more operational rules of the VOP 112 based on the trained dataset. Using the data collected over time by the available sensors, the control system 102 may detect patterns and trends, learning how to adjust behaviors of the VOPs 112 to become, for example, more useful and/or more efficient. For example, the control system 102 ensures that the right type of VOP 112 is in the right place at the right time to be ready to support anticipated activities or avoiding certain paths or path sections at certain times or under certain environmental conditions.

In an example embodiment, the control system 102 is further configured to continuously monitor the first set of parameters obtained at real-time, the Virtual Approved Pathway (VAP), the dynamic properties of the VOP 112, the one or more operational rules, the plurality of environmental conditions within the environment 106 the current position of the destination point, the predicted position of the destination point, and the possible movements of the destination point. Further, the control system 102 is configured to continuously train a dataset based on the monitored first set of parameters, the VAP, the dynamic properties of the VOP 112 and the one or more operational rules, the plurality of environmental conditions, the current position of the destination point, the predicted position of the destination point, and the possible movements of the destination point. Furthermore, the control system 102 is configured to update a VAP database with the trained dataset. The VAP database is maintained to store dynamic properties, routes of the VAPs and operational rules associated with the VAPs.

In an example embodiment, the control system 102 is configured to determine compatibility of the VOP 112 for navigation by mapping the dynamic properties and/or the operational rules of the VOP 112 with the properties and/or rules of the VAP. Furthermore, the control system 102 is configured to navigate the VOP 112, based on the determined compatibility. The determined compatibility may include for example, one of directionality restrictions, speed limitations, distance maintenance from other objects 110, and a lane assignment within the VAP. For example, the lane assignment may include choosing the most suitable lane for the VOP 112 to travel.

In one example embodiment, when the VOP 112 may be a person, then the control system 102 may “guide” a person, using the VAPs and environmental conditions, the first set of parameters, all the properties and rules and like. Specifically, the control system 102 may evaluate a requested Task, and calculate all the possible routes for all the—projected to be—available people, to then select the optimal route and assign the Task and the associated Trajectory to the selected Person. After which the control system 102 may continue to monitor the Person's execution of the Task, including comparing the Person's actual travel path to the calculated optimal Trajectory and possibly sending (“corrective”) guidance as instructions or commands to the one or more user devices 108A-N associated with the Persons.

### Exemplary Scenario-1

Consider a scenario of a warehouse environment 106 with VOPs (VOPs) 112 tasked with transporting goods between locations. In such an example, the control system 102 may manage the VOPs 112 and optimize their movements. In this example, the VOPs 112 may carry and deliver goods. The objects 110 may be goods, pallets, or other things the VOPs 112 move. The source point may be the starting location for an VOP 112 task. The destination point may be the ending location for the VOP 112 task.

In operation, a request may be received for an VOP 112 to move goods from a certain source location to the certain destination location. The control system 102 may identify available VOPs 112 and those VOPs 112 which are capable of handling the task. The control system 102 may consider factors such as VOP class (for example forklift, AMR, AGV, and the like), capabilities (for example weight capacity, size), characteristics (for example speed, maneuverability), and the like. The control system 102 may gather real-time data from the environment 106, including for example, but not limited to sensor data (for example temperature, obstacles), object properties (for example weight, dimensions), navigation objectives (for example fastest route, safest route), predefined rules for objects 110 (for example fragile items require special handling), priority levels for tasks, user-defined requirements (for example specific route preference) and the like. The control system 102 may then utilize a data-driven model (for example machine learning) to generate potential navigation plans for suitable VOPs 112. Each plan considers the VOP class and the capabilities, the environmental conditions, the predefined object rules and the priorities, the object properties, the navigation objectives and the user requirements or preference.

The control system 102 may correlate the navigation plans with task details, VOP parameters, and real-time data to determine the optimal plan. This plan may include for example, a VAP (Virtual Approved Pathway) connecting the source and destination locations, dynamic properties for the VOP 112 (for example speed adjustments while traveling through certain zones), operational rules for the VOP 112 within the VAP (for example following traffic rules) and the like. The control system 102 then guides the VOP 112 using waypoints along the chosen VAP. The control system 102 monitors the environment 106 and VOP 112 status. The control system 102 may update the navigation plan if environmental conditions change (for example obstacles appear), or if the destination point moves (for example due to human intervention), or if new data becomes available (for example, a shorter route is detected) and the like. This scenario exemplifies how the control system 102 manages the navigation of VOP 112 in a dynamic environment 106 using VAPs, real-time data, and machine learning for optimal task completion.

Though few components and subsystems are disclosed in FIG. 1, there may be additional components and subsystems which are not shown, such as, but not limited to, ports, routers, repeaters, firewall devices, network devices, databases, network attached storage devices, user devices, additional processing systems, servers, assets, machineries, instruments, facility equipment, any other devices, and combination thereof. The person skilled in the art should not be limiting the components/subsystems shown in FIG. 1. Although FIG. 1 illustrates the control system 102 is connected to one environment 106, one skilled in the art may envision that the control system 102 may be connected to several environments 106 located at same or various locations.

Those ordinary skilled in the art will appreciate that the hardware depicted in FIG. 1 may vary for particular implementations. For example, other peripheral devices such as an optical disk drive and the like, local area network (LAN), wide area network (WAN), wireless (for example wireless-fidelity (Wi-Fi)) adapter, graphics adapter, disk control system, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the control system 102 as is unique to the present disclosure or necessary for an understanding of the present disclosure is depicted and described. The remainder of the construction and operation of the control system 102 may conform to any of the various current implementations and practices that were known in the art.

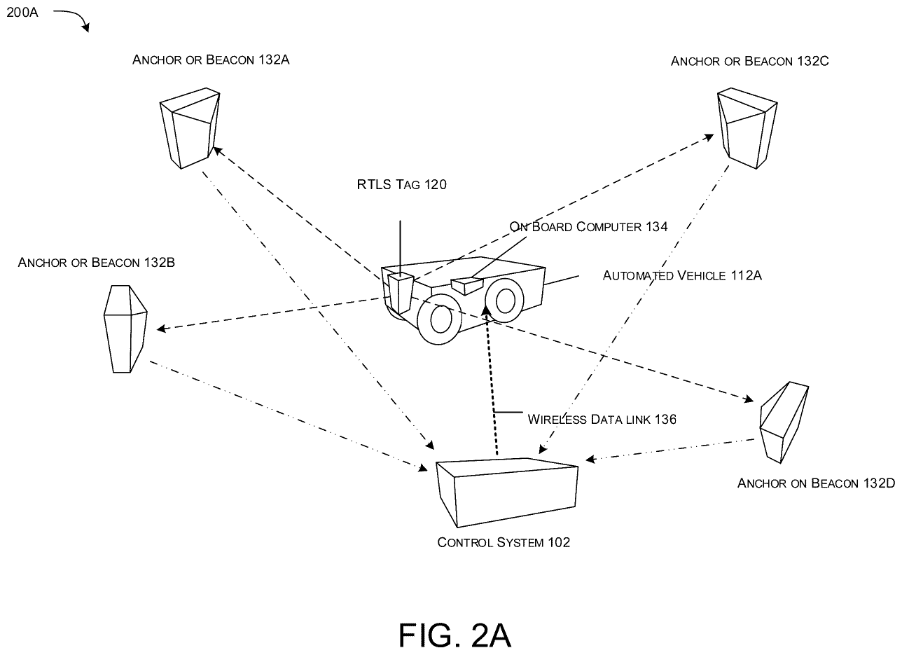

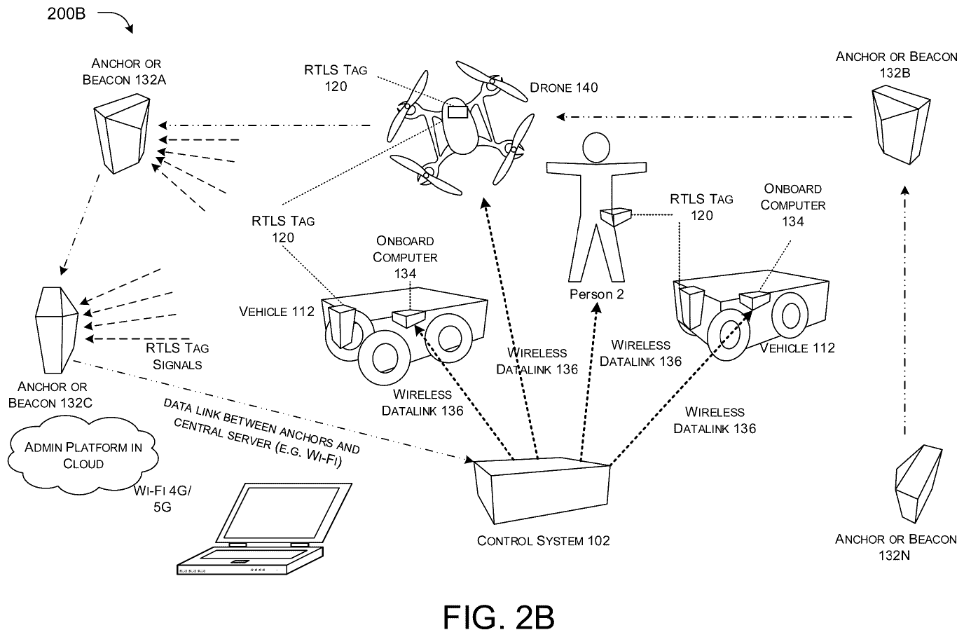

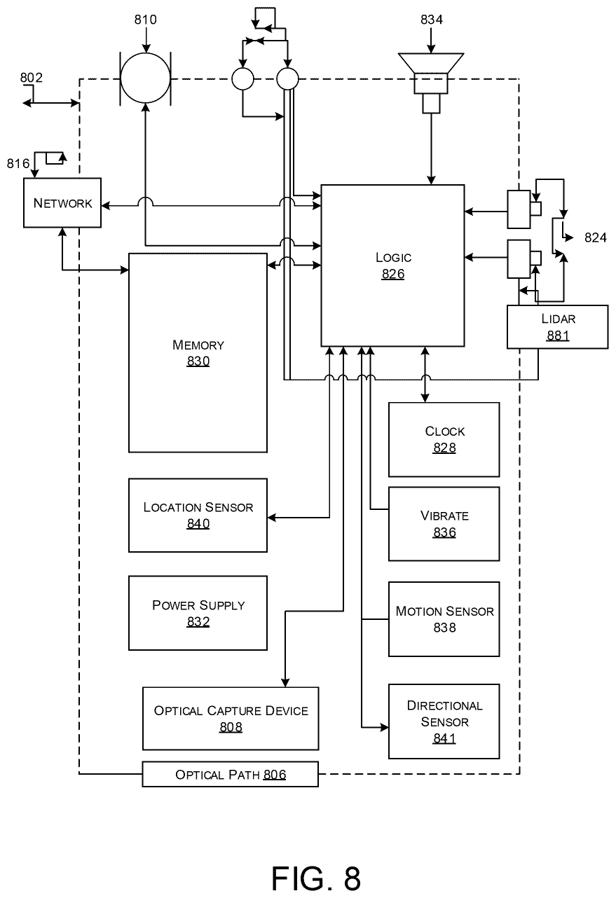

FIG. 2A is a schematic representation 200A of an exemplary environment comprising an exemplary VOP 112 co-located with a tag 120 which communicates with one or more anchors 132, in accordance with embodiments of the present disclosure. The present disclosure provides an Autonomous Vehicle System that includes one or more Tags 120 co-located with the VOP 112 and in communication via a wireless datalink 136 with control system 102. The tag 120 communicates with one or more anchors 132A-N and the control system 102 via the wireless datalink 136 within the environment 106. The wireless datalink 136 communications may include timing signals, position data, movement instructions (for example acceleration, velocity, direction) origination points, destination points, or other information related to travel of the VOP 112 through the physical environment 106. The VOP 112 may include on board computer 134. The on-board computer 134 is configured to process some part of the data captured by the VOP 112 via the sensors mounted on the VOP 112. The on-board computer 134 may also have network and communication interfaces (not shown) to communicate with the anchors 132A-N and/or the control system 102 or other VOPs 112 within the environment 106. A detailed view of the VOP 112 is depicted in FIG. 8.

According to the present disclosure, one or more of: current position coordinates, “intermediate” destination position coordinates (e.g., waypoints), and “final” destination coordinates may be generated as part of a sequence of positional coordinates to be travelled by the VOP 112. The position coordinates may be generated, by way of non-limiting example, via execution of software commands by the control system 102 that receives values for timing variables involved in the Wireless Datalink 136 communications and performs location determining algorithms, such as one or both of trilateration and triangulation or the like. Some preferred embodiments include the control system 102 to perform two way ranging (TWR) and/or time difference of arrival (TDOA) and/or reverse time difference of arrival (R-TDOA) and/or Angle of Arrival (AoA) protocols on respective wireless communications between the Tag 120 and at least four anchors including a first Anchor 132A, a second Anchor 132B, and a third Anchor 132C, or other Anchor 132N to determine a respective distance, such as, for example: between the tag 120 and the first Anchor 132A, the second Anchor 132B, the third Anchor 132C, or the other Anchor 132N. With typically three or more respective distances between the Tag 120 and the Anchors 132A-N, one or both of triangulation and trilateration may be used to generate position coordinates for the Tag 120. The position coordinates may include, for example, X, Y, Z cartesian coordinates. The control system 102 may generate the position coordinates associated with one or more VOP 112, the Tag 120, a smart device, or other apparatus or device with a processor and memory. The position coordinates are preferably generated on a periodic basis, such as once every 0.1 seconds or once every 2 seconds, depending upon particular circumstances. For example, a slow-moving VOP 112 may have a longer period of time between generation of new position coordinates, which may conserve battery life and bandwidth, and a faster moving VOP 112 may have a shorter period of time between determination of position coordinates. In some embodiments, a period of time between generation of the position coordinates may be based upon a projected and/or calculated velocity and/or acceleration of a VOP 112, such that for example if the VOP 112 is stationary, a period of time between generation of position coordinates may be two seconds, or more, and if the VOP 112 is moving quickly, a period of time between generation of position coordinates may be one tenth (0.1) of a second, or less.

FIG. 2B is a schematic representation 200B of another exemplary environment with multiple autonomous vehicles 112 and a person co-located with respective tags 120 which communicate with the one or more anchors 132A-N, in accordance with embodiments of the present disclosure. The exemplary environment comprises multiple VOPs 112 to navigate from source point to the destination point using the VAP. In an exemplary embodiment the person may be carrying one or more RTLS tags 120.

The control system 102 may generate a prescribed travel route comprising a series of current location point coordinates and destination point coordinates. The VOPs 112 may report current location point coordinates to the control system 102 and receive destination point coordinates for a next destination according to a periodic basis and/or upon a threshold. The threshold may be almost any quantifiable condition related to a VOP position and/or conditions within the environment 106.

Some exemplary threshold may include, one or more of: reaching a position proximate to a destination point traveling a prescribed distance, remaining stationary for a prescribed period of time (dwell time), a travel trajectory of another VOP 112, a travel trajectory that may collide with an obstruction, or other event that may be a condition precedent to a change in one or more of, a set of destination coordinates (which may correlate with a next destination, or a subsequent destination), a velocity of travel of the VOP 112, an acceleration rate of the VOP 112, a deceleration rate of the VOP 112, a rate of change of direction included in a travel trajectory, reaching a maximum number of VOPs 112 within a given set of position coordinates defining an area, experiencing a disrupting event within a given set of position coordinates defining an area (e.g. a spill, hazard or other adverse condition), and a pause or other delay of travel.

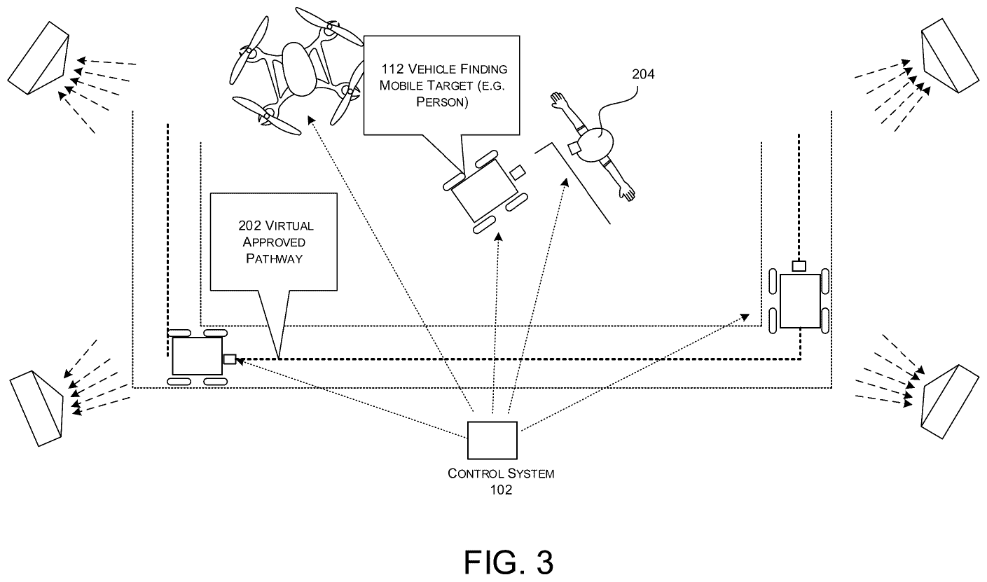

FIG. 3 is a schematic representation of example Virtual Approved Pathways (VAPs) 202 for multiple VOPs 112 and a mobile target 204, in accordance with embodiments of the present disclosure, in some embodiments. The Virtual Approved Pathway (“VAP”) 202 may be generated by a control system 102 and set forth a series of destination position coordinates. The VOP 112 may be transmitted with travel instructions that instruct the VOP 112 to move from one destination position coordinate to another. In some embodiments, a wayfaring tolerance may be included in the travel instructions. The wayfaring tolerance may include an acceptable variance to achieve “arrival” at a destination position coordinate. The tolerance may be a unit of distance measurement (for example within one meter) or a quantity of a numerical designation for position coordinates (for example within 10 units).

Some embodiments may include the control system 102 that guides the VOP 112 from a first position (which may optionally be defined by coordinates) to a second position, sometimes referred to as a destination position (also definable via position coordinates) that is generally a fixed position.

Embodiments may also include an instruction for the VOP 112 to be periodically regenerated to reflect a changing position of the mobile target 204. In an example embodiment, the position of the mobile target 204 as a destination position may be periodically monitored at a time “T” and adjusted to be synonymous with the position of VOP 112 at time T. Alternatively, a trajectory of a mobile target 204 may be calculated such that the VOP 112 may be programmed to intersect that trajectory of the mobile target 204. The mobile target 204 trajectory may be calculated for example by considering one or more factors such as for example, velocity, acceleration, and deceleration of the mobile target 204, obstructions in the path of the mobile target 204, restricted areas in the path of the mobile target 204, hazardous areas, or other condition that may impair travel of an VOP 112 and the like.

In some embodiments, a digital message may be transmitted to a smart device or other user device 108A-N indicating the arrival of the VOP 112 at a prescribed destination within a margin of error indicated by the tolerance (also referred herein as threshold value or limit value).

In some embodiments, precise real-time location of one or more VOPs 112 within a same physical space—is calculated based on the control system 102. The control system 102 may then transmit location information to VOPs 112 such as via a Wireless Datalink 136. This allows each VOP 112 to know the real-time position of each other VOP 112. The control system 102 also modifies travel trajectories and/or other behavior of the VOPs 112 (for example slow down) based on the calculated location, and/or trajectory within the environment 106 (for example shop floor) and based on its relative position compared to any other VOP 112 in its vicinity.

The present invention enables coordinated control of the behavior of VOPs 112 in real time, remotely, and in a centralized fashion, by modifying settings (for example the maximum allowed speed) or by defining the VAP 202 (for example new routes, new approved pathways, or new geofenced areas or the like).

In one example, the control system 102 may handle a large number of complex calculations. This significantly reduces the computational workload required onboard the VOP 112. As a result, the VOP 112 may benefit from one or more of the following: smaller batteries or a longer operating range or the like.

In various embodiments, the control system 102 may also perform one or more of: smoothing the trajectories (e.g. to comply with desired travel conditions), highlighting the portions of trajectories that are not feasible for specific classes of VOPs 112 due to geometric limitations of the VOP 112 (for example too sharp turn for turning radius of VOP 112) and/or under certain circumstances (for example meant to carry a wide load), creating an initial trajectory which may be manually modified, auto-suggesting corrections which may be accepted by a user, operator, and/or administrator, auto-adjusting or auto-smoothening or auto-correcting, the trajectories to create feasible pathways (possibly different for different classes of VOPs 112, based on a particular steering mechanisms).

Some embodiments may include optimizing the VAPs 202, such as for a smooth transitioning from one destination position to a next destination position, such as via one or both of: by smoothening the VAP 202, and by anticipating next waypoint(s) on the VAP 202.

Some embodiments include a user interface for optimizing and/or modifying properties via manual processes (for example, the VAP 202 allowed for certain VOPs 112, but not others, reactivate or disable, erase, and the like). The user interface may also allow a user to designate a path section (or select a number of path selections, for example by clicking on each section while holding “Control” or by dragging a box around the selected sections) to activate a drop down or pop-up control interface for accessing relevant settings that may be adjusted by a user.

In another aspect, in some embodiments, a VAP 202 may be dynamically adjusted by one or both of the control system 102 and a user interface based upon feedback from multiple active VOPs 112 operating in a same physical environment 106 (e.g. when a VOP 112 identifies an obstruction or congestion, the control system 102 may identify that path section as “blocked” and temporarily “unavailable”, until the control system 102 instructs an available VOP 112 to travel to that same area to investigate whether the obstruction has been removed yet, after which the path section may be switched back to “active” or “available”).

In some embodiments, an “off-trail mode” (“wander mode”) may be included that enables the VOP 112 to reach some station or target that is not located on a VAP 202, such as, by navigating as closely as possible to the station or target using VAPs 202, before taking the shortest off-trail route from there to reach the station or target (while using automatic emergency braking and obstacle avoidance along the way) and then return back to the VAP 202 in the same way in reverse.

In another aspect, some embodiments include a “grid mode” wherein the control system 102 translates a certain defined zone into a number of parallel (but connected) pathways (with a certain orientation and distance between the path ways and a certain travel direction) in order to assign a “grid” task to a certain VOP 112, or set of VOPs 112, instructing the VOP 112 or VOPs 112 to travel along a generated route of multiple sequential destination positions in order to perform some task, for example, but not limited to, sweeping or detecting or the like.

Still other embodiments include the ability for “motion planning/optimization” within VAPs 202 that have a certain defined “travel width” and thereby find an optimal VAP (for example similar to car racing, avoiding obstacles and taking into account slower or other-direction traffic along the way).

Another aspect includes “Temporary” or “Ad-Hoc” Virtual Approved Pathways wherein the control system 102 may, for example, keep track of bins, carts, or pallets being stored in, for example, an open warehouse area, in which case the control system 102 can define certain VAPs 202 dynamically, based on the specific circumstances, such as, by way of non-limiting example, inventory positions at a specified time, and assigning such “Temporary” or “Ad-Hoc” VAPs 202 to any VOPs 112 operating in the environment 106 at the time of job creation and job allocation (while making sure not to have any other VOPs 112 place inventory on those Temporary or Ad Hoc VAPs in the meantime).

In some embodiments, a tag 120 (or “RTLS Tag”) refers to an electronic, typically battery-operated device (positional sensor) that communicates with Anchors 132A-N and/or other Tags to determine its real-time location, and therefore the real-time location of the VOP 112 o it is associated with (for example mounted in or on). Some Tags 120, operated in certain ways, are able to calculate their own real-time location. Some embodiments may include a Tag 120 that broadcasts a unique identification number but does not need to perform any position calculations itself. In such embodiments, the computing devices 124 may perform positioning calculations and VAP 202 determination, saving significant battery power in an associated Tag 120 and enabling new capabilities and use cases.

Similarly, an Anchor 132A-B (for example a “RTLS Anchor”) may include an electronic device that communicates with other Anchors 132A-B and/or Tags 120 and a control system 102 to determine the real-time position of all active Anchors 132A-N and/or Tags 120 within an environment 106. In some embodiments, one or more Anchors 132A-N may include a control system 102 capable of calculating positions, generating VAPs 202, and other processes described herein.

The control system 102 uses the data received from the Anchors 132A-N and/or Tags 120 to calculate and/or gather real-time location data. In some embodiments, the control system 102 generates conditions of one or more Tags 120 at an instance in time. The conditions of Tags 120 may include, by way of non-limiting examples, one or more of: direction, velocity, acceleration, deceleration, pitch, yaw, roll, or other metric quantifiable via logical processes and/or operation of a sensor or the like. The control system 102 may process conditions and locations of multiple active anchors 132A-N and tags 120 within a single physical environment 106, or multiple defined physical environments 106. The control system 102 may be operative to transmit real-time location information over a Wireless Datalink 136 to some or all Tags 120 co-located with VOPs 112 and/or people within the environment 106. The control system 102 may also provide other relevant data to the on-board computer 134 on any VOPs 112 involved, or to user devices used by any people involved, including location-based conditions (such as for example slippery conditions or obstacles), location-based rules (such as a maximum allowed speed in a certain geofenced area), specific commands (for example job requests), and certain alerts (such as for example collision risks).

The On-Board Computer 134 may be collocated with the VOP 112 (such as integrated into or supported by the VOP 112) and be able to receive information from the control system 102 via transmissions using the Wireless Datalink 136. The information received may include, by way of non-limiting example, a real-time location of a Tag 120 associated with (such as, mounted in or on) the VOP 112 at an instance in time, a real-time location of another VOP 112 within its environment 106, the location of certain geofenced areas, and any associated rules (for example maximum speed), specific commands (for example job requests), and specific alerts (for example collision risk). The On-Board Computer 134 may use information received from the control system 102, as well as data received for example from other on-board sensors, to make decisions on such as a speed and direction of travel for an associated VOP 112, and possibly adjusting its behavior multiple times during a single travel session.

The person positioned within a same physical environment 106 as operating VOPs 112 may be equipped with a Tag 120 such that a real-time position of the Person may be determined by the control system 102 and shared with other control systems, such as control systems 102 on VOPs 112, automation, equipment, machinery, or People. The person equipped with a personal computing device, such as a Smart Device (for example a smart phone, smart watch, smart glasses, or tablet) may run executable software to make the smart device operative to receive position information (one or both of real time location and historical location information) of all or specific VOPs 112. This allows the person to make decisions and adjust his or her behavior and actions.

### Exemplary Operation:

In some embodiments, the VOP 112 is collocated or otherwise equipped with a Tag 120, which is placed in or on the VOP 112. The multiple anchors 132A-N are positioned around and/or within a physical environment 106 in which the VOP 112 is operating. The anchors 132A-N exchange RF signals with the Tag 120 and send resulting information to the control system 102 over Ethernet or Wi-Fi connection or the like.

Using the information received from the anchors 132-N, the control system 102 determines the real-time location of the Tag 120 on the VOP 112 and therefore the location of the VOP 112 itself at an instance in time. Besides the real-time location of the VOP 112, the control system 102 may also use the information received from the Anchors 132A-N to determine details associated with the tag 120 (for example direction, speed, acceleration, and the like of the VOP 112).

The control system 102 provides the real-time location (and possibly direction, speed, acceleration, and the like) of the VOP 112 to the on-board computer 134 of VOP 112, using a Wireless Datalink 136. In some embodiments, the On-Board Computer 134 of VOP 112 may also receive inputs from a number of other sensors, such as, for example, one or more of: Inertial Measurement Units (IMUs), LiDAR sensors, ultrasonic sensors, wheel encoders, vision cameras, or other IoT devices or the like.

Specialized algorithms running on the On-Board Computer 134 or VOP 112 may be used to implement certain logic that combines different sensorial inputs to achieve specific desired behaviors, such as navigating to a target location, following a pre-defined route, slowing down in certain areas, and the like. In an example embodiment of the present disclosure, an open-source Robotic Operating System (ROS) may be used, but alternative libraries, drivers, and tools may be available or may be developed.

A Graphical User Interface (GUI) screen provides a user-friendly manner for people to interact with the control system 102, allowing to impact and control the behavior of the VOP 112 remotely. Voice controls may be used to interact with the control system 102 and/or with the individual VOP 112, in order to convey certain commands and affect certain actions and behaviors.

Wireless Datalink 136 refers to an apparatus and methods enabling communication of data in a wireless manner. Communication may be accomplished using technologies such as, one or more of: Wi-Fi, Bluetooth, LoRa, UWB, or the like. In some embodiments, a Wireless Datalink 136 may be made operative to provide wireless communication of data and information from a control system 102 to VOPs 112 and other control systems. This data and information may include, for example, but not limited to, an estimated position, direction, speed, and acceleration of some, or all of the VOPs 112 and People involved. The data may also include, for example, conditions and rules that may be position related.

In various embodiments, the control system 102 may be operative for all or some of the calculations referenced to calculate variables associated with the operation of the VOP 112 in a physical environment 106, such as, for example one or more of: locations, directions, speeds, and accelerations. Alternatively, the control system 102 may gather and communicate this and any other relevant data to one or more VOPs 112 and people involved. While use of the control system 102 to communicate real-time positioning data is preferred, it is also possible to calculate an VOP 112 position by or on the VOP 112 itself, in order to make the VOP 112 operative to execute logic and to generate instructions to control the VOP 112. This may be particularly useful for instructions governing quick, short-term, and/or short-distance travel.

Instead of a single control system 102, there may be multiple control systems 102 that may exchange information between them.

The control system 102 may be implemented as on-premises computers, or be cloud-based, or some mix between the two. The anchors 132A-N are preferably implemented as fixed infrastructure (one or more Anchors 132A-N mounted on walls and/or ceilings) but may also be mounted on, for example, mobile tripods for more flexible or temporary deployments.

In some embodiments, one or more Tags 120 may be made operative to fulfil the role of one or more Anchors 132A-N. The anchors 132A-N may be networked to a server in different ways, either wired or wireless. Each anchor 132A-N may have a direct (for example Ethernet) link to the control system 102, or certain anchors 132A-N may be daisy-chained together. Some or all the anchors 132A-N may also communicate with the control system 102 wirelessly, for example over a Wi-Fi connection.

The wireless data link 136 needed to communicate the centrally available real-time location (and direction, speed, acceleration, and the like) does not necessarily need to be secure. However, a secure link is highly preferred, to reduce security risks. Besides or instead of a Graphical User Interface (GUI) it is also possible to use alternative user interfaces, such as a command line interface.

Unlike VOPs 112, People are not controlled by on-board computers 134, but any of the real-time location data available on the control system 102 may be shared with People as well, by sending it to e.g., their smart phone or tablet.

The VOPs 112, or simply Vehicles, referred to in this document include any types of machines that have some method of propulsion and some method of steering, and that may be made to exhibit automated or autonomous behaviors, including but not limited to moving from one location to another within a certain physical space. The information obtained about the estimated position, direction, speed, and acceleration of any VOP 112 or People could be shared not only with VOPs 112 and People that are operating in the same physical space, but possibly also with VOPs 112 or People that are operating in different physical spaces. This would allow for behavior replication or behavior duplication in different physical spaces. The components and concepts described herein may be referred to by other nomenclature, such as, for example anchors 132A-N may be referred to as beacons, position and location may largely be used interchangeably; direction and orientation may be used interchangeably, speed and velocity may also be used interchangeably.

The VOP 112 may be operative via executable software to know the real-time position of any other objects 131 that also carry Tags 120, thereby enabling safe operation. The VOPs 112 may modify their behavior depending on whether another nearby object is a Vehicle or a Person or multiple People, slowing down and/or keeping a further distance when approaching or being approached by People. The Person wearing a Tag 120 may be notified whenever a Vehicle (or possibly another Person) is approaching them, possibly on a collision course that may be obstructed from view.

Specific areas may be defined (“geofenced”) centrally, on or via the control system 102, with specific parameters such as maximum allowed speed, minimum distance, and the like. Then, as the VOP 112 knows its real-time position relative to these geofenced areas, it may modify its behavior based on the area it is navigating through or towards (slow down or avoid altogether). The VOPs 112 may also be told remotely to increase their distance from certain other Vehicles, People, or any other known objects 110, in order to increase safety.

The VOP 112 may be provided with a specific, fixed location (a location coordinate or location name) in the space where it is operating, for the VOP 112 to autonomously navigate towards that location. Moreover, the VOP 112 may also be given the Tag ID or some other unique identification (such as a universally unique identifier or name) of a mobile object, for the VOP 112 to navigate towards, find, and meet up with that mobile object—all while moving around safely and possibly following Virtual Approved Pathways 202. This capability makes it possible for VOPs 112 to find and retrieve mobile carts that are not always in a same exact physical location, and/or bring certain materials, equipment or tools to people that need these materials, equipment, or tools, but are moving around a shop floor. The VOP 112 may come or go to find a specific Object or Person, anywhere within the physical space covered by the Anchors 132A-N, by using a voice command with the Object 110 or Person's unique Tag ID.

In an example. specific routes for the VOP 112 to follow may be established by defining a set of digital coordinates, also called waypoints. These waypoints may be defined in a number of different ways. They may be established for example, by physically moving a Tag 120 along the desired route and recording the Tag's position along the way. The waypoints may also be established on the control system 102, either through a terminal using some (graphical) user interface or using a wearable device such as a smart phone or tablet, by tracing or drawing them on a graphical representation (such as a floor plan) of the environment 106 where the VOP 112 is or will be operating. Virtual Routes may be established, managed, and updated on the control system 102 and shared with any VOPs 112 involved using the Wireless Datalink 136 or some other wireless datalink.

Beyond establishing a specific Virtual Route for the VOP 112 to follow, it is also possible to define (for example record or draw as described above) a network of virtual routes that specific VOPs 112 are allowed to choose from when navigating from one point to another. In some embodiment, either the control system 102 or the VOP 112 itself may use specialized algorithms, including, for example, path optimization techniques, in order to choose a route that is most desirable, such as, for example, one or more of: safest, shortest, fastest, or most efficient. The control system 102 or the VOPs 112 may also pick an alternate route from the available approved pathways in case a preferred route is not available (for example blocked). The Virtual Approved Pathways 202 may be established, managed, and updated on the control system 102 and shared with any VOPs 112 involved using the Wireless Datalink 136 or some other wireless datalink. This also makes it possible to modify the set of Virtual Approved Pathways 202 automatically, in case some problem, such as for example, an obstruction, is detected, possibly by another VOPs 112 encountering the problem. By sending updated Virtual Approved Pathways 202 to other VOPs 112 involved, the other VOPs 112 may modify their routes, to avoid the same obstacle, until the issue is resolved.

VOPs 112 (or herein also referred to as Vehicles or Persons), connected to the control system 102 over a Wireless Datalink 136, may know each other's precise and real-time absolute locations and relative positions, and share any relevant information such as for example, location-based conditions. The present disclosure also allows for the integration with enterprise systems, such as for example, Enterprise Resource Planning (ERP), Manufacturing Execution Systems (MES), Advanced Planning and Scheduling (APS), and Warehouse Management Systems (WMS), in order to communicate further relevant data to any VOPs 112 involved, for example providing them with real-time job instructions.

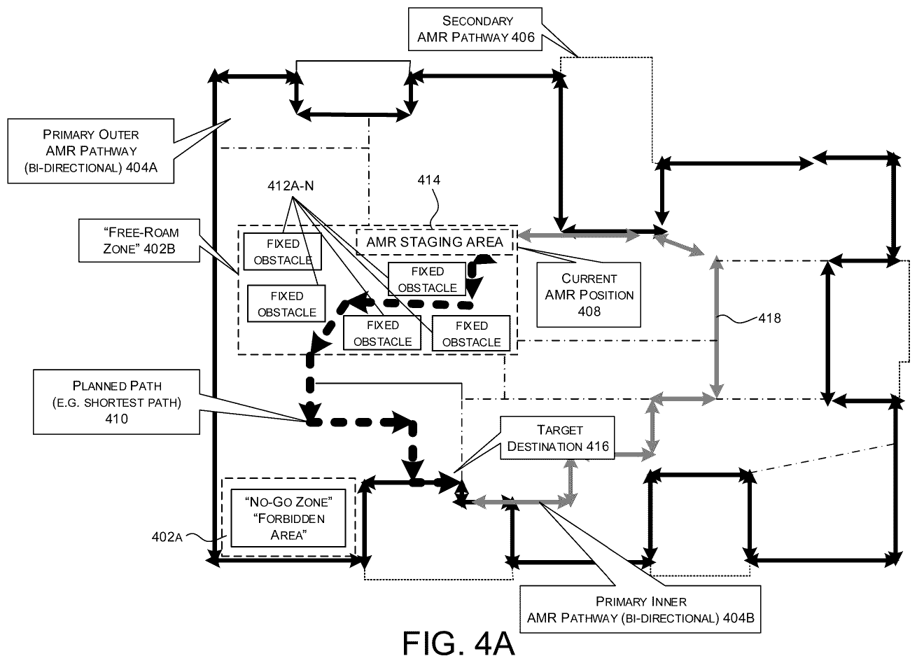

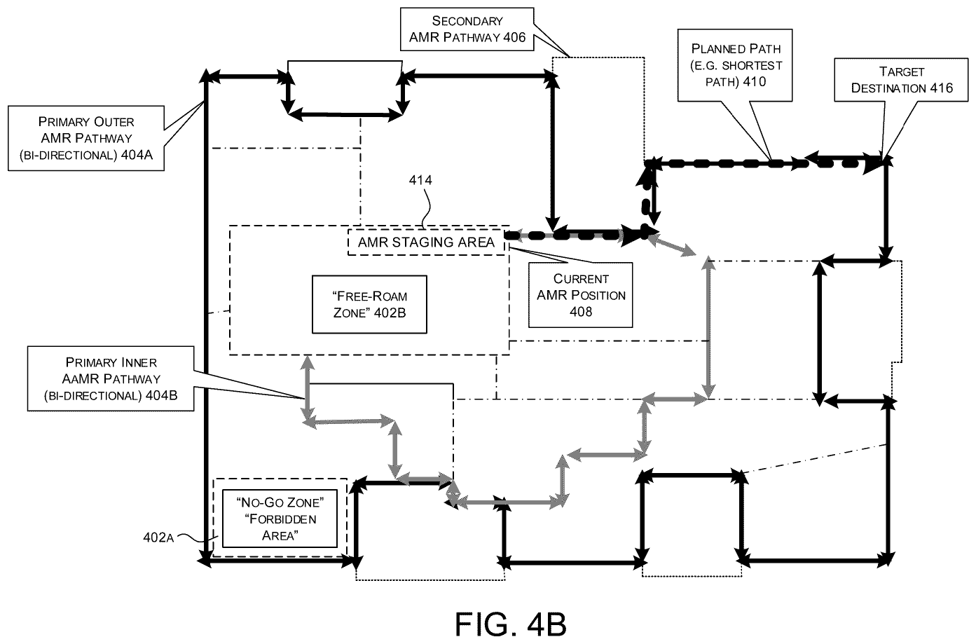

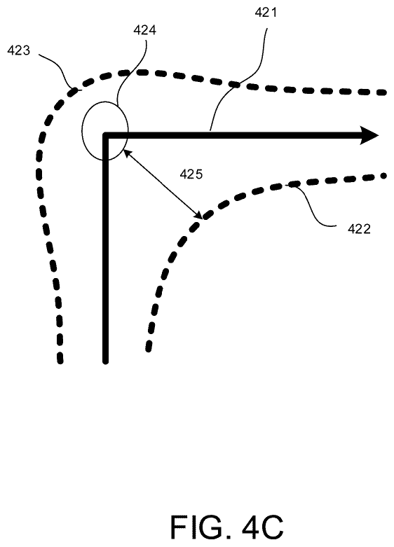

FIG. 4A-C is a schematic representation of an exemplary graphical user interface screen depicting a virtual representation of the environment 106 with various Virtual Approved Pathway (VAPs) 410 for an automated vehicle or person (or “VOP” 112), in accordance with embodiments of the present disclosure. According to some embodiments of the present invention (and as illustrated) a two-dimensional surface layout of representing a physical environment 106 and virtual pathways 410 that an VOP 112 may travel according to a series of current position designations and destination positions is depicted. Other embodiments may include a three dimensional or perspective view in a user interface.

An exemplary user interface is shown with various user interactive portions. As illustrated, an VOP position 408 is shown adjacent to staging area 414. The VOP 112 (not illustrated) may travel along VAP 410 to reach a destination 416. The VAP 410 circumvents one or more obstacles 412A-N that prevent the VOP 112 from traveling in a direct line path to reach destination 416. The VAP 410 traverses a Free-Roam Zone 402B in which the VAP may take any path not obstructed by an obstacle 412A-N. Other zones include a No Go Zone 402A which is designated as being off limits to VOP travel. The control system 102 or user that attempts to generate a VAP 410 that traverses a No Go Zone 402A may be excluded from including waypoints that fall with the No Go Zone 402A. However, in some embodiments, an administrator or other user with the proper credentials and authority level, may authorize traversing a No Go Zone 402A. In some embodiments, an alternate VAP 406 may also be generated and one or both VOP 112 and a user may choose the alternate VAP 406 to have the VOP 112 reach the destination 416. Selection of the alternate VAP 406 may also be guided by vehicle parameters and/or first set of parameters and/or environmental conditions, such as maximum speed of a VOP 112 on a VAP 410, 404, 406, number of changes in direction (turns) along the VAP 410, 404, 406, congestion on the VAP 410, 404, 406, surface conditions on the VAP 410, 404, 406 (for example roughness, bumps, liquids, ice, and the like) and the like.

As illustrated, in some embodiments, a user interface, and corresponding logic referenced by the control system 102 in charting a VAP 410, 404, 406, may include one or more Primary Paths 404A-B and/or Secondary Paths 406. A path for an VOP 112 may be designated as a Primary Path 404A-B or Secondary Path 406, based upon one or both of: logic used to generate a path with a control system 102, and user preference. In some embodiments, the primary path 404A-B and/or Secondary Path 406 may be so designated based upon a type of VOP 112 that will travel the path, contents carried by the VOP 112, congestion, events in the physical environment 106 (for example change of shift, materials restocking, maintenance events, cleaning, or any other occurrence or variable that may influence the experience of a VOP 112 traversing the path) and the like.

In some implementations, logic used by one or both of a control system 102 and a user may be sourced with values for variables considered in generating a VAP 410, 404, 406. Variables may include, by way of non-limiting example, a cargo carried by the VOP 112. A Cargo may include, for example, a liquid that may move within a container carried by the VOP 112 if the VOP 112 is required to make sharp turns, accelerate, decelerate, stop, traverse irregular surfaces and the like.

Accordingly, surface conditions may influence and/or dictate a choice that logic makes in generating a VAP 410, 404, 406. Other consideration may include how close an VOP 112 may bring an VOP 112 (and the VOP cargo) to persons, sensitive equipment, other VOPs 112, ambient environmental conditions, and almost any other variable that may be influenced by or influence an VOP 112 and/or VOP cargo. In some embodiments, sensors, such as IoT sensors may monitor environmental conditions and values descriptive of the environmental conditions may be included as variables in a logical process that generates a VAP 410, 404, 406. By way of non-limiting example, variables may include a maximum and/or minimum temperature range of an environment 106 along a VAP 410, 404, 406, an amount of static, electromagnetic radiation, nuclear radiation, biologic contamination (including contamination to food stuffs), moisture and/or liquid exposure, airborne particulate, and almost any other condition quantifiable with a sensor.

In FIG. 4B, an alternate use case of the user interface depicting an alternate positions or locations of the VOPs 112, target destination 416, and VAPs 410, 404, 406 are disclosed.

In FIG. 4C, a VAP 421 may have a variance tolerance that allows for an actual path travelled 422-423 to deviate from a path of prescribed destination points 416. A variance tolerance 425 may be based upon a physical distance (for example up to 0.5 meter from a prescribed destination point 416 and/or path) or a percentage of width of a VAP 421 (for example 10% of VAP width). In some embodiments, a variance tolerance of 425 may be adjusted for conditions under which an VOP 112 is operating. For example, a VOP 112 under full load may be allowed a greater variance, a VOP 112 operating in conditions with very little other VOP traffic may be allowed a greater variance tolerance and/or to operate at faster speeds, and a VOP 112 entering an area 424 including persons, and/or sensitive equipment or machines may be limited to very slow speed and very small variance tolerance.

Other variables that may be included in logic used to generate a VAP 410, 404, 406 may include a path that: is fastest, shortest, highest speed, lowest speed, most energy efficient, preferred point of travel (for example path is monitored by camera or person), least likely to have stops or slow-downs, favorable surface conditions (textured to prevent slipping, smoothest, painted, coated, low static, rubberized, no need to open or close doors (for example areas with cold storage, clean rooms, controlled environment 106 of moisture, heat, particulate, static, and the like) need for ingress/egress a room or area, need to actuate doors, desire to rotate stock, collision avoidance, required turns (obstacles) tipping, slowing, cargo shifting.

In some embodiments, the control system 102 or other control system generating a VAP 410, 404, 406 may receive data from one or more IoT devices collocated with a VOP 112 that monitor variables indicative of conditions during operation of the VOP 112. Conditions may include, for example, tilting, tipping, temperature, agitation, vibration, impact, acceleration, deceleration, and ceased movement.

The capabilities enabled by the present invention are highly relevant and useful in a diverse range of environments 106 and industries, including but not limited to Manufacturing, Materials Management, Logistics, Healthcare and Eldercare. For example, in Manufacturing and Materials Management, The present invention allows for autonomous Vehicles that: a VOP 112 may find and retrieve the right materials, parts, equipment or tools, as and when they are needed, no matter where they are on the shop floor or in the warehouse where the Vehicles are operating and bring the right materials, parts, equipment or tools to the right workstation as they are needed.

In another aspect, a Just-In-Time or Just-In-Sequence process may be enabled via moving a mobile work platform from workstation to workstation as a product is being assembled. The VOP 112 may retrieve, pick up, transport, and drop off one or more of: parts, materials, equipment, and people safely and autonomously across and around a plant or warehouse floor, using VOP 112 (such as, automated carts, robots, forklifts, utility terrain vehicles or other carrier or automation that are enabled with the intelligent autonomous capabilities made possible using the apparatus and methods presented herein.

In some embodiments, the present invention enables VOP 112 to find and retrieve a person or item(s). For example, a Person (for example an Order Picker) who needs—or is expected to need—a Vehicle such as a picking cart, waits around in a safe location until needed, then the cart is dispatched to follow the Person as the Person loads materials onto the Vehicle. The VOP 112 may then autonomously take the loaded materials to where they are needed, such as, for example to a manufacturing station, or for packaging and shipping. A next picking routine may be supported by a next VOP 112 that is available.

In some examples, in healthcare, the present invention allows for VOP 112 that transport people safely and autonomously around a clinic or hospital environment and bring needed medical equipment (for example crash carts), medications, or other materials to where they are needed, autonomously, safely, timely, and expeditiously. In Eldercare, the present invention allows for VOPs 112 that transport people safely and autonomously around the care or retirement home or community and bring needed equipment or supplies to where they are needed, autonomously, safely, timely, and expeditiously.

Embodiments herein provide apparatus and methods for improved operation of an VOP 112 that traverses a defined path wherein the path is based upon positioning determined via wireless communication. The VOP 112 mobilizes from its current position to the next destination position. The current position and next position are associated with a set of positional coordinates. Positional coordinates may also have an acceptable tolerance such that if the VOP 112 is positioned proximate to a set of positional coordinates, the control system 102 issuing mobilization commands may consider the VOP 112 to have reached a destination position and move to a next destination position in a sequence of destination positions.

In some embodiments, positioning may be augmented via additional modalities offering diverse methods and apparatus for determining a position of the VOPs 112 such as accelerometers, infrared sensors, LiDAR, SLAM, image recognition, and the like. In some embodiments, a control system 102 may operate according to a hierarchy of position determining modalities. For example, the control system 102 may place UWB positioning as a highest prioritized modality and image recognition as a lower priority positioning modality.

The control system 102 defines a series of origination positions and destination positions, each destination position correlating with position coordinates. Control commands are provided to the VOP 112 to cause the VOP 112 to propel itself to each successive destination position based upon the current location of the robot and direction the robot is facing.

In an embodiment, position coordinates may be a set of values that accurately define a position in two dimensional 2D or three-dimensional (3D) space. The position coordinates may include by way of non-limiting example one or more of: cartesian coordinates (for example X, Y, Z), polar coordinates (for example angle and distance), and cylindrical coordinates (for example angle, distance, and height).

The present invention provides for determination of a current position definable via the positional coordinates via wireless communications. Preferred wireless communications are performed via an ultrawideband communication modality. Other communication modalities may include, for example, Bluetooth, Wi-Fi, infrared, cellular, RFID, and GPS.

As described herein, in some embodiments, a series of positional coordinates are defined in sequence. A trajectory is generated to guide VOP 112 from its current position to the next destination point. On a periodic basis, wireless communications are utilized to calculate a current position, the trajectory may be updated following determination of each current position, or upon reaching some set value, or minimum set value of current position calculations. The control system 102 delivers control commands, such as, for example, digital command or analog power to the VOP 112 to cause the VOP 112 to traverse from its current position to a next destination position.

Some embodiments additionally include drawing a path on a smart device or other control system interface, the path may overlay a 2D or 3D representation of an environment 106. The path may be transcribed into a series of multiple destination points. Unlike previously known control systems, a series of origination positions interior to a building may be calculated via UWB communications (or other wireless communications) between a transceiver collocated with the VOP 112 and transceivers located at know reference points (“Anchors” 132). In addition, the present invention provides for handoff of UWB communications between the Tag 120 and sets of multiple disparate Anchors 132A-N, each anchor 132 coordinated with a single origination point from which positional coordinates may be calculated.

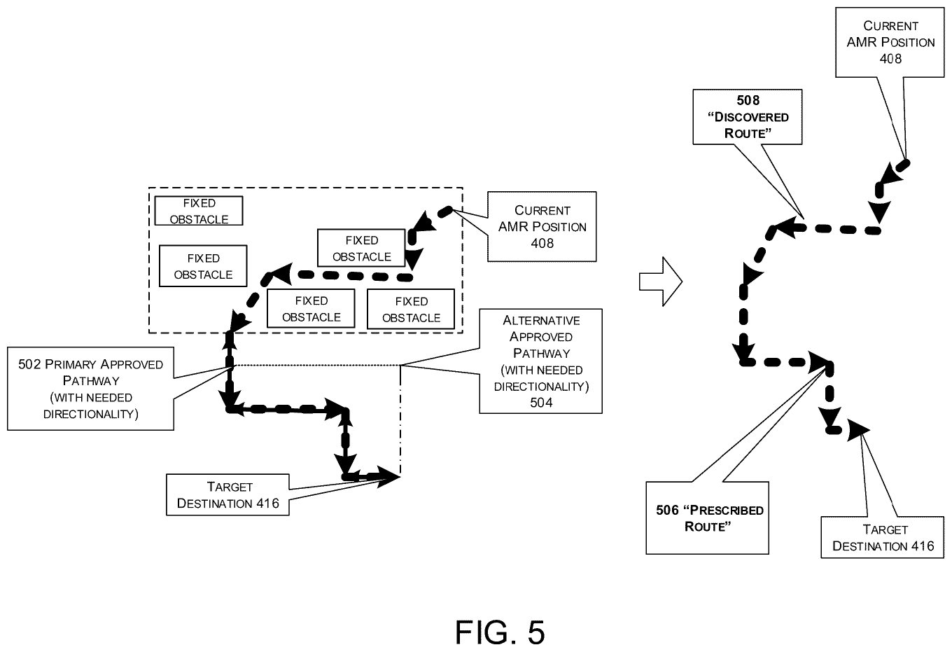

FIG. 5 is a schematic representation of an exemplary graphical user interface screen depicting a portion of the virtual representation while determining an optimal navigation plan for the VOP, in accordance with embodiments of the present disclosure. In an embodiment, a process of managing tasks for Automated Mobile Robots (AMRs) or VOPs 112 within an environment 106 using Virtual Approved Pathways (VAPs) 202 (also referred herein as VAP 421, 410, 404, 406).

FIG. 5 depicts generating optimal trajectories based on zones, properties and rules associated with the zones and the VOPs 112. In an example, The VOPs 112 while executing a certain task are aware about a task type (e.g. “Go To”, “Find”, or the like), its current position 408 and target destination 416, Virtual Approved Pathways 502, 504, 506 and 508 (with all associated “rules”, such as directionality, speed, and the like), Free-Roam Zones 402B (to be navigated/crossed using the shortest safe path between VAPs leading to and from the Free-Roam Zone), No-Go Zones 402A (to be navigated around may be areas around certain obstacles such as equipment, but also open areas) and the like.

Obstacles are usually unknown by the VOP 112 ahead of time. These are detected and avoided along the way (using for example cameras, ultrasonic sensors, radar, LiDAR, and the like). In an example embodiment, in a “Free-Roam Zone”, the control system 102 finds the shortest safe path along the virtual approved pathways that leads to the destination 416. A discovered route 508 navigates the VOP 112 to the closest VAP needed to reach the destination 416, while avoiding any obstacles along the way. Alternatively, a prescribed route 506 is chosen which refers to the set of selected path points (coordinates) along pre-defined Virtual Approved Pathways, selected by the control system 102, to reach the destination 416 in for example the shortest, quickest, and or safest way.

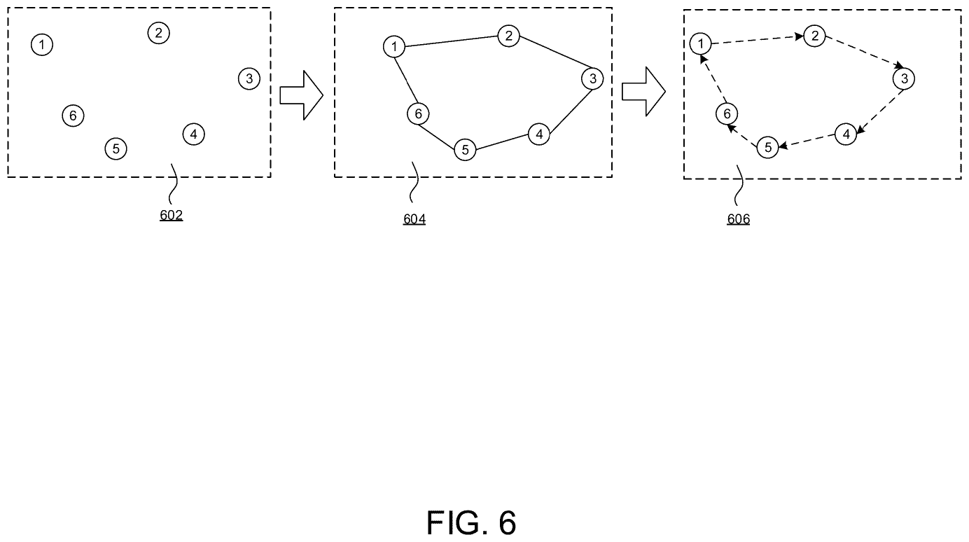

FIG. 6 is a schematic representation depicting an exemplary process of defining Virtual Approved Pathway (VAP) 202, in accordance with embodiments of the present disclosure. Path points are essentially designated points that create the path. The present disclosure offers two methods for defining VAPs. In the first method, the VAPs may be defined by manually defining path points. In this method, the path points are manually identified to specify the VAP. The order in which the path points are defined may determine the directionality of the path, or the directionality may be set in a separate step. The VAPs are defined by identifying path points at step 602 (the order of path point definition may define directionality, or directionality may be defined or modified in a separate step). In the second method, the VAPs may be defined by drawing or walking the pathway. The control system 102 may automatically identify path points as the user draws or walks the desired path. The direction of the drawing or walking may by default set the directionality of the path, but this may also be defined or modified later. This may be used even if no floor plan is available. The control system 102 may record either the entire path (a dense set of coordinates) or just specific path points chosen by the operator. The control system 102 may switch between the physical and virtual world. This means that control system 102 may define a path by walking it with a special tag, 120 and the control system 102 may immediately show the path on screen, including automatically identified key points. Then, this path may be modified in the virtual world (for example straighten it, smooth it out). At step 602, the path points are identified. At step 604, order of the paths is defined. At step 606, directions of the path points are defined.

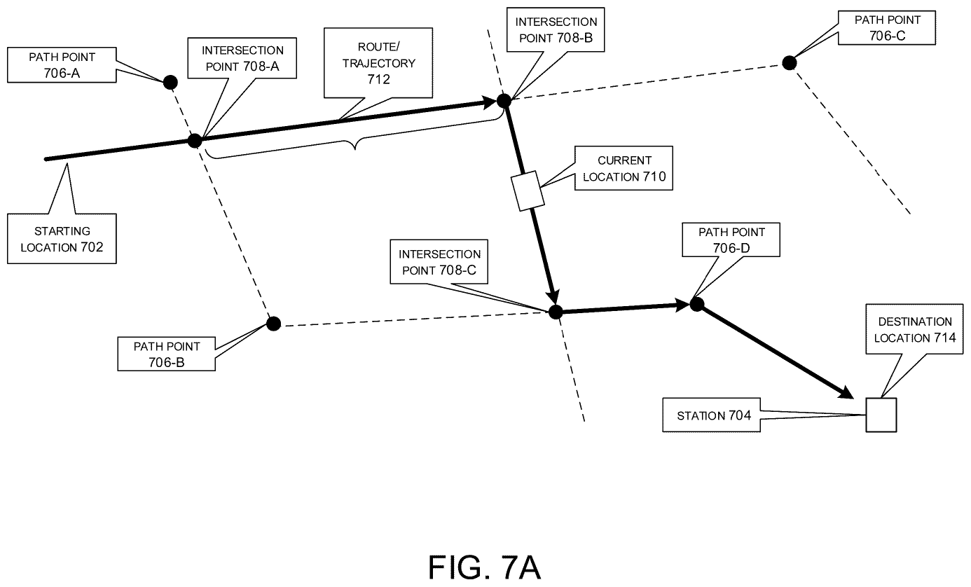

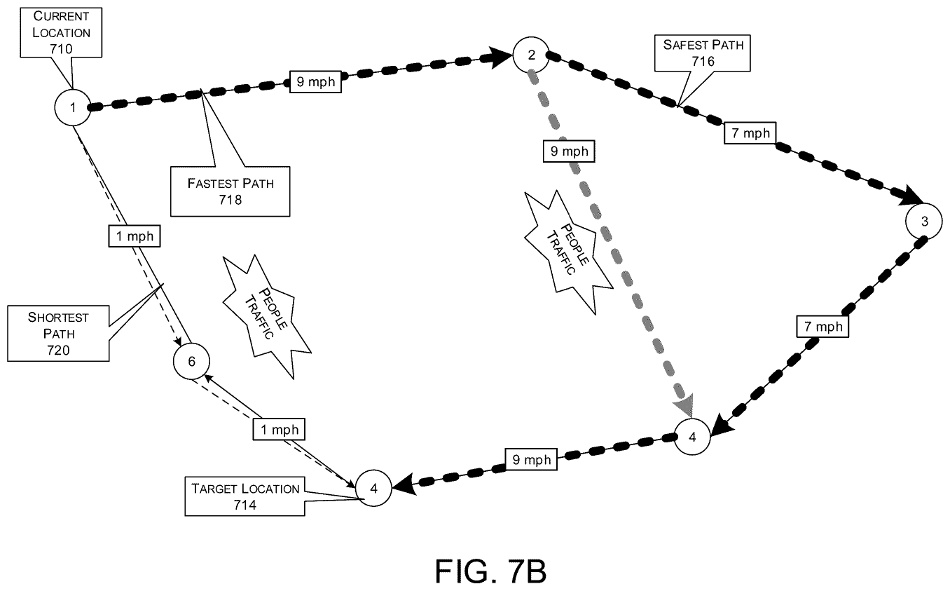

FIG. 7A-B are schematic representations of an exemplary graphical user interface screen depicting a portion of the virtual representation for selecting optimal trajectory(s) among best possible trajectories for the VOP 112), in accordance with embodiments of the present disclosure. In an embodiment, a navigation system may include a starting location 702 for the VOP 112, a destination location 714, a current location 710, one or more path points 706A-N, one or more intersection points 708A-N, and a route/trajectory 712. The one or more path points 706A-N may refer to any point along a designated path, including start, end, and intermediary points. A path section may include a segment of an approved pathway between two intersection points. The intersection point 708A-N may be for example a junction where two or more paths meet. The pathway may include any combination of approved paths. The VOPs 112 may use path points 706A-N and the intersection points 708A-N for determining the best possible route for navigation. In FIG. 7B, a comparison of three paths: shortest, fastest, and safest is depicted. In this embodiment, a possible delivery environment, with three designated paths originating from a common starting point (current location) and terminating at a designated endpoint (target location) 714 is depicted. The arrows indicate the direction of travel of VOP 112 along each path. The shortest path 720 prioritizes minimal distance, potentially for efficiency purposes. This path is labeled with a speed of 1 mph. The fastest path 718 prioritizes speed for time-sensitive deliveries. This path 718 is labeled with a speed of 9 mph. The safest path 716 prioritizes elements that contribute to safe navigation, such as wider paths or areas with less traffic or pedestrians. The path is labeled with a speed of 7 mph.

FIG. 8 is a block diagram of an exemplary smart device 800 depicting various hardware components of the smart device, in accordance with embodiments of the present disclosure. The smart device 800 may include an optical capture device 808 to capture an image and convert it to machine-compatible data, and an optical path 806, typically a lens, an aperture, or an image conduit to convey the image from the rendered document to the optical capture device 808. The optical capture device 808 may incorporate a Charge-Coupled Device (CCD), a Complementary Metal Oxide Semiconductor (CMOS) imaging device, or an optical Sensor 824 of another type.

A microphone 810 and associated circuitry may convert the sound of the environment 106, including spoken words, into machine-compatible signals. Input facilities may exist in the form of buttons, scroll wheels, or other tactile Sensors such as touchpads. In some embodiments, input facilities may include a touchscreen display.

Visual feedback to the user is possible through a visual display, touchscreen display, or indicator lights. Audible feedback 834 may come from a speaker or other audio transducer. Tactile feedback may come from vibrate module 836.

A motion Sensor 838 and associated circuitry convert the motion of the mobile device 800 into machine-compatible signals. The motion Sensor 838 may comprise an accelerometer that may be used to sense measurable physical acceleration, orientation, vibration, and other movements. In some embodiments, motion Sensor 838 may include a gyroscope or other device to sense different motions.

A location Sensor 840 and associated circuitry may be used to determine the location of the device. The location Sensor 840 may detect Global Position System (GPS) radio signals from satellites or may also use assisted GPS where the mobile device 800 may use a cellular network to decrease the time necessary to determine location.

The mobile device 800 includes logic 826 to interact with the various other components, possibly processing the received signals into different formats and/or interpretations. Logic 826 may be operable to read and write data and program instructions stored in associated storage or memory 830 such as RAM, ROM, flash, or other suitable memory. It may read a time signal from the clock unit 828. In some embodiments, the mobile device 800 may have an on-board power supply 832. In other embodiments, the mobile device 800 may be powered from a tethered connection to another device, such as a Universal Serial Bus (USB) connection.

The mobile device 800 also includes a network interface 816 to communicate data to a network and/or an associated computing device. Network interface 816 may provide two-way data communication. For example, network interface 816 may operate according to the internet protocol. As another example, network interface 816 may be a local area network (LAN) card allowing a data communication connection to a compatible LAN. As another example, network interface 816 may be a cellular antenna and associated circuitry which may allow the mobile device 800 to communicate over standard wireless data communication networks. In some implementations, network interface 816 may include a Universal Serial Bus (USB) to supply power or transmit data. In some embodiments other wireless links may also be implemented.

As an example of one use of mobile device 800, a reader may input 802 a drawing with the mobile device 800. In some embodiments, the drawing may include a bit-mapped image via the optical capture device 808. Logic 826 causes the bit-mapped image to be stored in memory 830 with an associated timestamp read from the clock unit 828. Logic 826 may also perform optical character recognition (OCR) or other post-processing on the bit-mapped image to convert it to text.

A directional sensor 841 may also be incorporated into the mobile device 800. The directional device may be a compass and be based upon a magnetic reading or based upon network settings.

A LiDAR sensing system 881 may also be incorporated into the mobile device 800. An associated sensor device, sensitive to the light of emission may be included in the control system 102 to record time and strength of returned signal that is reflected off of surfaces in the environment 106 of the mobile device 800.

Using real-time location data, calculated or collected on the control system 102 and shared over a secure Wireless Datalink 136, the present invention provides control to coordinate movements and activities of Vehicles and/or People (VOPs) 112 that navigate around a shared physical space.

A centralized approach, as described herein has numerous advantages, including but not limited to: being able to orchestrate safe and efficient navigation and collaboration between Vehicles and/or People (VOPs) 112 operating within a shared physical space, enabling autonomous Vehicles and/or People to modify their behavior (including, for example, slow down) based on both their absolute location within the overall environment 106 (e.g. shop floor) and their relative position compared to any other Vehicles and/or People 112 in their vicinity, and enabling flexible control over the behavior of any autonomous vehicles and/or people live, remotely, and in a centralized fashion, by modifying settings (e.g. the maximum allowed speed) or by defining e.g. new routes, approved pathways, geofenced areas, and the like by a control system 102.

The described methods and apparatus enable non-autonomous vehicles to be converted into autonomous vehicles, and to upgrade the capabilities of existing (“traditional”) autonomous vehicles into more intelligent and more capable autonomous Vehicles, by adding a Real-Time Locating System (RTLS) and implementing a version of the current invention to control the Vehicles' behavior and configure relevant parameters on the controller using a (graphical) user interface.

The described methods and apparatus are highly scalable and may be used to control a single Vehicle, as well as to control and coordinate multiple or many Vehicles and/or People at once. Ultimately, the present invention enables true Vehicle-to-Vehicle (V2V), Vehicle-to-Infrastructure (V2I), and Vehicle-to-People (V2P) interaction and orchestration.

FIG. 9 is an exemplary block diagram representation of a control system 102, depicting various hardware components, capable of controlling VOPs 112 using Virtual Approved Pathways (VAPs), in accordance with embodiments of the present disclosure. The computer system 900 may be part of or any one of the control systems 102, the VOP 112, the computing devices 124, and the RTLS anchors 132A-N, or the like to perform the functions and features described herein. The computer system 900 may include, among other things, an interconnect (not shown in FIG. 9), a processor 905, a storage 910, a computer readable medium 915, a RAM 920, an output device 925, an input device 930, a data source 945, a data source interface 940, and a network communicator 935.

The interconnect (not shown in FIG. 9) may interconnect various subsystems, elements, and/or components of the computer system 900. As shown, the interconnect may be an abstraction that may represent any one or more separate physical buses, point-to-point connections, or both, connected by appropriate bridges, adapters, or control systems. In some examples, the interconnect may include a system bus, a peripheral component interconnect (PCI) bus or PCI-Express bus, a Hyper Transport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect may allow data communication between the processor 905 and system memory, which may include read-only memory (ROM) or flash memory (neither shown), and random-access memory (RAM) 920. It should be appreciated that the RAM 920 may be the main memory into which an operating system and various application programs may be loaded. The ROM or flash memory may contain, among other code, the Basic Input-Output system (BIOS) which controls basic hardware operation such as the interaction with one or more peripheral components.

The processor 905 may be the central processing unit (CPU) of the computing device and may control the overall operation of the computing device. In some examples, the processor 905 may accomplish this by executing software or firmware stored in system memory or other data via the storage 910. The processor 905 may be, or may include, one or more programmable general-purpose or special-purpose microprocessors, digital signal processors (DSPs), programmable control systems, application specific integrated circuits (ASICs), programmable logic device (PLDs), trust platform modules (TPMs), field-programmable gate arrays (FPGAs), other processing circuits, or a combination of these and other devices.

The multimedia adapter (not shown in FIG. 9) may connect to various multimedia elements or peripherals. These may include a device associated with visual (for example video card or display), audio (for example sound card or speakers), and/or various input/output interfaces (for example mouse, keyboard, touchscreen).

The network communicator 935 may provide the computing device with an ability to communicate with a variety of remove devices over a network and may include, for example, an Ethernet adapter, a Fiber Channel adapter, and/or another wired- or wireless-enabled adapter. The network communicator 935 may provide a direct or indirect connection from one network element to another and facilitate communication between various network elements.

The storage 910 may connect to a standard computer-readable medium for storage and/or retrieval of information, such as a fixed disk drive (internal or external).

Many other devices, components, elements, or subsystems (not shown) may be connected in a similar manner to the interconnect or via a network. Code or computer-readable instructions to implement the dynamic approaches for payment gateway selection and payment transaction processing of the systems and methods may be stored in computer-readable storage media such as one or more of system memory or other storage. Code or computer-readable instructions to implement the dynamic approaches for payment gateway selection and payment transaction processing of the systems and methods may also be received via one or more interfaces and stored in memory.

The control system 102 may be included in one or more of: a wireless tablet or handheld device, a server, a rack mounted processor unit. The control system 102 may be included in one or more of the apparatuses described above, such as a Server, and a Network Access Device.

In some examples, the processor 905 may be supplemented with a specialized processor for AI related processing. The processor 905 may also cause the communication device to transmit information, including, in some instances, control commands to operate apparatus to implement the processes described above. The processor 905 and storage devices 910 may access an AI training component (not shown) and database, as needed which may also include storage of machine learned models.

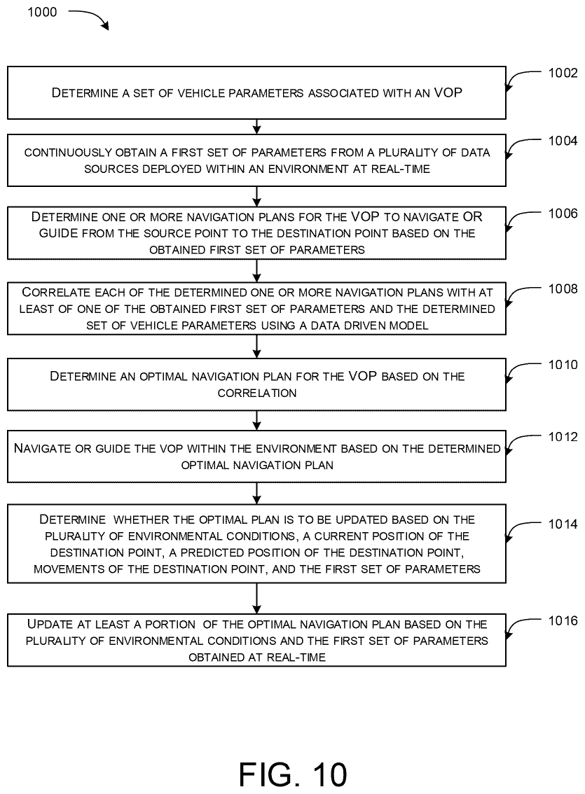

FIG. 10 is a flow chart depicting an exemplary method of controlling VOPs 112 using Virtual Approved Pathways (VAPs), in accordance with embodiments of the present disclosure. At step 1002, the method 1000 includes determining, by a processor 905, a set of parameters associated with a VOP 112. The set of parameters comprise at least one of a class, capabilities, characteristics, and requirements associated with the VOP 112. The VOP 112 is dynamically configured to navigate from a source point to a destination point based on one or more tasks being requested.

At step 1004, the method 1000 includes continuously obtaining, with the processor 905, a first set of parameters from a plurality of data sources deployed within an environment 106, in real-time. The first set of parameters comprise sensor data, one or more properties associated with a plurality of objects 110, one or more navigation objectives, a plurality of pre-defined rules associated with each object within the environment 106, a plurality of priority levels, and one or more user-defined requirements. The plurality of objects 110 comprises at least one of sensors, one or more VOPs 112, one or more load objects 116, one or more cart objects 118, and one or more obstacles 122, one or more computing devices 124, and one or more real-time location system (RTLS) tags 120.

At step 1006, the method 1000 includes determining, with the processor 905, one or more navigation plans for capable VOPs 112 predicted to be available at the requested time, and dynamically configured to navigate from the source point to the destination point based on the obtained first set of parameters. Each of the one or more navigation plans corresponds to at least one of a plurality of classes of VOPs 112, a plurality of environmental conditions, the plurality of pre-defined rules and the plurality of priority levels, the one or more properties associated with each object within the environment 106, the one or more navigation objectives and the one or more user-defined requirements.

At step 1008, the method 1000 includes correlating, with the processor 905, each of the determined one or more navigation plans with the one or more tasks to be performed by the one or more VOPs 112, at specific times, the at least one of the obtained first set of parameters and the determined set of parameters, using a data driven model.

At step 1010, the method 1000 includes determining, with the processor 905, an optimal navigation plan for the VOP 112 based on the correlation. The optimal navigation plan comprises at least one Virtual Approved Pathway (VAP) connecting the source point with the destination point via a plurality of path points, dynamic properties to be configured with the VOP 112, and one or more operational rules to be followed by the VOP 112 while navigating on the at least one Virtual Approved Pathway (VAP). In some embodiments, when the VOPs 112 include people 112B, the dynamic properties and the operational rules to be followed are configured into user devices carried by the people 112B.

At step 1012, the method 1000 includes navigating or guiding, with the processor 905, the VOP 112 within the environment 106 based on the determined optimal navigation plan, wherein the VOP 112 is guided by one or more waypoints acting as path indicators.

At step 1014, the method 1000 includes determining, with the processor 905, whether the optimal navigation plan is to be updated based on the plurality of environmental conditions, a current position of the destination point, a predicted position of the destination point, possible movements of the destination point, and the first set of parameters.

At step 1016, the method 1000 includes updating, with the processor 905, at least a portion of the optimal navigation plan based on the plurality of environmental conditions and the first set of parameters obtained in real-time.

The present disclosure provides systems and methods for optimizing navigation of Automated Vehicles or People (referred herein as VOPs 112) within an environment 106 covered by a Real-Time Location System (RTLS). Specifically, the present system controls a sequence of origin and destination waypoints for the VOP 112, while considering acceptable acceleration and velocity parameters. This approach ensures safe and efficient pathfinding for the VOP 112 to reach its designated endpoint.

In one example operation, the VOP 112 may receive instructions from the present system to mobilize from a current position to a next destination position. Both the current position and the next destination position may be defined by a set of spatial coordinates. These spatial coordinates may incorporate a degree of tolerance, allowing the present system to consider that the VOP 112 has reached the next destination position when the VOP 112 has arrived within a permissible proximity of the destination position.

According to the present disclosure, the present system operates various mobile entities, such as both automated vehicles 112A and people 112B, within environment 106. These mobile entities may be collectively referred to as “Vehicles or Persons” (VOPs) 112. Such mobile entities may include, for example, but not limited to, Automated Guided Vehicles (“AGV”s), Autonomous Mobile Robots (“AMR”s), Humanoid Robots, Autonomous Aerial Vehicles (sometimes referred to as “AAV”s or “drones”), and/or People (collectively referred to as a “VOP” 112, in singular, or “VOPs” 112, in plural). VOPs 112 may be operated in real-world settings such as for example, but not limited to, manufacturing floors, warehouses, hospitals and the like. In an example embodiment, the present system may generate specific control commands which may be transmitted to the VOPs 112 through a continuous wireless communication system, such as, for example, but not limited to, a Real-Time Location System (RTLS).

This system typically consists of Anchors 132, Tags 120, a control system 102, and local area network (“LAN”) equipment. The exchange of Radio Frequency (RF) signals between tags 120 and anchors 132 allows for the calculation of position of both entities (tags 120 and anchors 132) within the environment 106. These position calculations are performed by one or more processors 905 executing dedicated software. The location of these processors 905 and software may vary and may reside in any of the following, the Tag 120, the anchor 132, the on-board computers 134, the one or more computing devices 124 or the like. The Tags (also referred herein as RTLS tags) 120 may be physically attached to various assets, including for example, but not limited to, plurality of objects 110 including, VOPs 112, material, parts, tools, equipment, AGV, AAV, AMR, or the like. By calculating the position of the Tag 120, the position of an associated asset may be derived.

In an example embodiment, the present system may utilize various machine learning algorithms to analyze and predict future values of various travel variables associated with the mobile entities within the environment 106. These travel variables may include, but are not limited to positions, velocity, acceleration, deceleration, altitude, and proximate obstacles over time. By analyzing historical data of these travel variables, the various machine learning algorithms may accurately predict their future values. This allows for proactive management and optimization of movement within the environment 106. In some implementations, the present system goes beyond predicting the travel variables. The present system may combine these travel variables with additional data describing the asset associated with the tracked entity (for example material type for a tagged package). This combined analysis allows for predicting one or more actions involving the tracked asset.

The one or more actions may include for example, but not limited to, recharge battery before reaching a critical level, adjust route to avoid congestion or prioritize urgent deliveries, Wait for loading/unloading based on estimated arrival times, pick up materials from a designated location based on real-time inventory data, adjust route to avoid obstacles or find alternative paths, return to charging station when battery levels are low, navigate to specific location for task assignment, request assistance for heavy lifting or complex tasks, take a break based on ergonomic factors or pre-programmed schedules, move to designated storage area based on type and capacity constraints, expedite delivery for time-sensitive materials, trigger reorder for materials nearing expiry or low stock levels and the like.

The present invention leverages a Real-Time Location System (RTLS) to provide real-time positioning and movement data of multiple automated vehicles and/or persons (VOPs) 112 within a specified range. This data is securely transmitted to a control system 102 via a wireless datalink. The control system 102 may utilize the received data to achieve several objectives. The objectives may include to provide positioning and movement data of multiple automated vehicles and/or persons (VOPs) 112 within a specified range and operating in a same environment 106, to coordinate activities in the environment 106, and safely and efficiently control respective positions such that the vehicles and/or persons 112 to avoid colliding or interfering with each other.

In an embodiment, the present system allows users to directly interact with the control system 102 by drawing a travel path on a smart device (or other control system interface). This path may preferably be integrated with a two-dimensional (2D) or a three-dimensional (3D) representation of the environment 106, providing a clear visual reference. The user-defined travel path may be automatically transcribed into a series of multiple destination points for the vehicle or person (VOP) 112 to follow. This provides a more intuitive and user-friendly approach compared to traditional control systems. Unlike traditional control systems, a series of origination positions interior to a building may be calculated via UWB communications (or other wireless communications) between a transceiver (which may be a “Tag” 120) collocated with a vehicle, person and/or robot 112, and transceivers located at known reference points (“Anchors” 132). This calculation leverages Ultra-Wideband (UWB) communications (or other suitable wireless communication protocols) between a transceiver (which may be a “Tag” 120) collocated with the VOP 112 and transceivers strategically placed at known reference points (“Anchors” 132). Unlike previous control systems, these anchors 132 are not limited to the perimeter of the building.

In addition, the present system allows for seamless “handoff” of UWB communication between the tag 120 and sets of multiple, and disparate Anchors 132. Each Anchor 132 is coordinated with a known location within the environment 106, ensuring accurate positioning and navigation even in complex indoor settings. This handoff capability facilitates uninterrupted communication and tracking as the VOP 112 traverses the designated path.

In the following sections, detailed descriptions of examples and methods of the disclosure will be given. The description of both preferred and alternative examples though thorough, are exemplary only, and variations, modifications, and alterations may be apparent to those skilled in the art. It is therefore to be understood that the examples do not limit the broadness of the aspects of the underlying disclosure as defined by the claims.

A number of embodiments of the present disclosure have been described. While this specification contains many specific implementation details, there should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings, and the detailed description thereto are not intended to limit the present disclosure to the form disclosed, but to the contrary, the present disclosure is to cover all modification, equivalents and alternatives falling within the spirit and scope of embodiments of the present disclosure as defined by the appended claims.

The headings used herein are for organizational purposes only and are not meant to be used to limit the scope of the description or the claims. As used throughout this application, the word “may” be used in a permissive sense (i.e., meaning having the potential to), rather than the mandatory sense (i.e., meaning must). Similarly, the words “include”, “including”, and “includes” mean including but not limited to. To facilitate understanding, reference numerals have been used, where possible, to designate elements common to the figures.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” may be used interchangeably herein. It is also to be noted the terms “comprising”, “including”, and “having” may be used interchangeably.

Certain features that are described in this specification in the context of separate embodiments may also be implemented in combination in a single embodiment. Conversely, various features that are described in the context of a single embodiment may also be implemented in combination in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Certain features that are described in this specification in the context of separate embodiments may also be implemented in combination in a single embodiment. Conversely, various features that are described in the context of a single embodiment may also be implemented in combination in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Moreover, the separation of various system components in the embodiments described above should not be understood as requiring such separation in all embodiments, and it should be understood that the described program components and systems may generally be integrated together in a single software product or packaged into multiple software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

In certain implementations, multitasking and parallel processing may be advantageous. Nevertheless, it will be understood that various modifications may be made without departing from the spirit and scope of the claimed disclosure.

What is claimed:

1. A method for controlling or guiding one or more automated vehicles or people (VOPs) in an environment using virtual approved pathways (VAPs), comprising:
determining, with a processor, a set of parameters associated with a vehicle or person (VOP), wherein the set of parameters comprise at least one of: a VOP class, capabilities, characteristics, and requirements associated with the VOP, and wherein the VOP is dynamically configured or guided to navigate from a source point to a destination point based on one or more tasks requested;
continuously obtaining, with the processor, a first set of parameters from a plurality of data sources deployed within the environment, in real-time, wherein the first set of parameters comprise sensor data, one or more properties associated with a plurality of objects, one or more navigation objectives, a plurality of pre-defined rules associated with each object within the environment, a plurality of priority levels, and one or more user-defined requirements, wherein the plurality of objects comprises at least one of sensors, one or more VOPs, one or more load objects, one or more cart objects, and one or more obstacles, one or more computing devices, one or more user devices, one or more real-time location system (RTLS) tags;
determining, with the processor, one or more navigation plans for capable VOPs predicted to be available at a requested time, and dynamically configured to navigate from the source point to the destination point based on the obtained first set of parameters, wherein each of the one or more navigation plans corresponds to at least one of a plurality of classes of VOPs, a plurality of environmental conditions, the plurality of pre-defined rules and the plurality of priority levels, the one or more properties associated with each object within the environment, the one or more navigation objectives and the one or more user-defined requirements;
correlating, with the processor, each of the determined one or more navigation plans with the one or more tasks to be performed by the one or more VOPs, at specific times, the at least one of the obtained first set of parameters and the determined set of VOP parameters, using a data driven model;
determining, with the processor, an optimal navigation plan for the VOP based on the correlation, wherein the optimal navigation plan comprises at least one Virtual Approved Pathway (VAP) connecting the source point with the destination point via a plurality of path points, dynamic properties to be configured with the VOP, and one or more operational rules to be followed by the VOP while navigating in the at least one Virtual Approved Pathway (VAP) navigating, with the processor, the VOP within the environment based on the determined optimal navigation plan, wherein the one or more VOPs are guided by one or more waypoints acting as path indicators;
determining, with the processor, whether the optimal navigation plan is to be updated based on the plurality of environmental conditions, a current position of the destination point, a predicted position of the destination point, possible movement of the destination point, and the first set of parameters; and
updating, with the processor, at least a portion of the optimal navigation plan based on the plurality of environmental conditions and the first set of parameters obtained in real-time.

2. The method of claim 1, further comprising:
simulating, with the processor, the determined optimal navigation plan in a virtual environment for validating the determined optimal navigation plan, wherein the virtual environment emulates a physical environment; and
deploying, with the processor, the determined optimal navigation plan in the physical environment based on results of simulation.

3. The method of claim 1, further comprising:
controlling or guiding, with the processor, the VOP based on the updated optimal navigation plan, the plurality of environmental conditions and the first set of parameters obtained in real-time.

4. The method of claim 1, wherein determining the optimal navigation plan for the VOP based on the correlation comprises:
retrieving, with the processor, one or more Virtual Approved Pathways (VAPs) within the environment from at least one of the one or more VOPs and the plurality of objects, using real time location systems (RTLS) and one or more sensors;
determining, with the processor, one or more zones and stations existing within the environment based on the first set of parameters, wherein the one or more zones comprise one of a free roaming zone, a no-go zone, and an intersection zone, wherein the VOP is configured or guided to choose a desired trajectory when in free-roaming zone until the VOP exits the free roaming zone, and wherein the VOP is configured or guided to restrict navigating via the no-go zone, and wherein the VOP is configured or guided to modify its behavior, such as performing a temporarily halt and then traveling at reduced speed, while transversing the intersection zone;
determining, with the processor, one or more best possible trajectories for navigation of the VOP based on the obtained one or more VAPs and the one or more zones and stations, wherein each trajectory comprises the plurality of path points, and wherein each trajectory is guided by the one or more waypoints;
identifying, with the processor, an optimal trajectory among the determined one or more best possible trajectories for the VOP based on one of the plurality of classes of VOPs, the plurality of environmental conditions, the plurality of pre-defined rules and the plurality of priority levels, the one or more properties associated with each object within the environment, the one or more navigation objectives and the one or more user-defined requirements;
determining, with the processor, the one or more operational rules to be followed by the VOP based on the identified optimal trajectory;
determining, with the processor, the dynamic properties to be configured with the VOP based on the determined one or more operational rules;
defining, with the processor, the at least one Virtual Approved Pathway (VAP) connecting the source point with the destination point via the plurality of path points; and
defining, with the processor, at least one priority level of the plurality of priority levels for the VOP based on the defined VAP, the one or more operational rules, and the dynamic properties to be configured with the VOP.

5. The method of claim 1, wherein defining the at least one Virtual Approved Pathway (VAP) connecting the source point with the destination point via the plurality of path points comprises:
identifying, with the processor, the plurality of path points between the source point and the destination point using a Real-Time Location System (RTLS); and
generating, with the processor, a route from the source point to the destination point, wherein the route comprises the identified plurality of path points.

6. The method of claim 4, wherein determining whether the optimal navigation plan is to be updated based on the plurality of environmental conditions, the current position of the destination point, the predicted position of the destination point, the possible movement of the destination point, and the first set of parameters comprises:
continuously monitoring, with the processor, current location of the VOP relative to the identified optimal trajectory to determine whether the VOP deviates greater than a threshold distance value from the optimal trajectory of the at least one Virtual Approved Pathway (VAP);
determining, with the processor, the plurality of environmental conditions, the current position of the destination point, the predicted position of the destination point, and the possible movement of the destination point, wherein the plurality of environmental conditions are determined using one or more sensors present within the environment, wherein the one or more sensors comprise sensors associated with the one or more VOPs, and wherein the current position of the destination point is determined using at least one of the RTLS and peer VOPs currently deployed in the environment;
determining, with the processor, one or more possible collision events on the at least one Virtual Approved Pathway (VAP) based on the determined plurality of environmental conditions and the first set of parameters obtained in real-time; and
creating, with the processor, one of a temporary VAP in addition to a current VAP, an updated VAP, and a new VAP for the VOP, based on the determined one or more possible collision events, the plurality of environmental conditions, the current position of the destination point, the predicted position of the destination point, and the possible movement of the destination point, wherein the temporary VAP inherits specific properties and rules from the at least one VAP.

7. The method of claim 6, further comprising:
generating, with the processor, visual representations of the environment in real-time using at least one of RTLS tags and the one or more sensors deployed within the environment, wherein the visual representations comprise a plurality of virtual elements corresponding to each of the plurality of objects deployed in the environment and wherein the visual representations comprise of a map of the environment;
determining, with the processor, the properties and movements associated with each of the plurality of virtual elements depicted in the generated visual representations, wherein each virtual element of the plurality of virtual elements is configured to perform one of inherit and overrule one of properties and rules of other virtual elements based on the plurality of environmental conditions and based on an absolute location of the virtual element within the environment and/or based on a relative position of the virtual element relative to some or all of the other virtual elements;
determining, with the processor, a plurality of rules associated with each of the plurality of virtual elements depicted in the generated visual representations;
comparing, with the processor, the determined properties, the movements, and the plurality of rules associated with the plurality of virtual elements with corresponding pre-defined properties, pre-defined movements, and pre-defined rules stored in a database; and
determining, with the processor, whether the optimal navigation plan is to be updated based on the comparison.

8. The method of claim 7, wherein generating the visual representations of the environment in real time comprises:
creating, by the VOP, at least one Simultaneous Locating and Mapping (SLAM) map of the environment while navigating along the at least one VAP using one or more RTLS tags; and
transmitting, by the VOP, the created SLAM map to a control system or to the one or more VOPs within the environment.

9. The method of claim 7, wherein generating the visual representations of the environment in real-time comprises:
generating, by a processor of a user device, an augmented-reality (AR) based representation as a visual representation of a physical environment, wherein the AR-based representation comprises the plurality of virtual elements emulating the plurality of objects within the physical environment, the one or more VAPs, one or more destinations, trajectories, current and historical locations of the plurality of virtual elements, the properties and rules associated with the plurality of virtual elements; and
obtaining, with the processor, user interaction with the plurality of virtual elements via the generated AR-based representation, wherein the user interaction comprises at least one of:
visualizing, with the processor, location and movements of static elements and dynamic elements in real-time, at specific past and future points in time, wherein the static elements correspond to the one or more VAPs, the one or more zones, and one or more stations defined within the environment, respective rules and properties associated with each of the one or more VAPs, the one or more zones and stations, and wherein the dynamic elements correspond to the one or more destinations, the plurality of environmental conditions, tasks, destination points, targets, temporary VAPs, trajectories, and travel intent, and wherein the visualization comprises one of replaying the past locations of the plurality of virtual elements at previous points in time, replaying movements of the plurality of virtual elements during past periods in time, future locations of the plurality of virtual elements predicted to be at future periods in time;
accessing and modifying, with the processor, the properties and rules associated with the plurality of virtual elements; and
interacting and modifying, with the processor, the plurality of virtual elements on the AR-based representation.

10. The method of claim 9, wherein generating the augmented-reality (AR) based representation as one of the visual representation of the physical environment comprises:
projecting, with the processor, the AR-based representation onto an AR capable device associated with a user, wherein the AR-based representation comprises the plurality of virtual elements, the properties and the rules associated with the plurality of virtual elements superimposed in real-time, onto a graphical user interface screen of the AR capable device.

11. The method of claim 1, further comprising:
identifying, with the processor, potential conflicts between the Virtual Approved Pathways (VAPs) and capabilities of a specific class of VOP, based on the dynamic properties of that class of the VOP;
visually representing, with the processor, the identified conflicts as graphical representations on a graphical user interface; and
generating, with the processor, one or more solutions for rectification of the identified potential conflicts and directing tasks and activities to be performed by the VOP; and
receiving, with the processor, a user-approved solution from a user from among the generated one or more solutions.

12. The method of claim 1, wherein updating at least the portion of the optimal navigation plan based on the plurality of environmental conditions and the first set of parameters obtained in real-time comprises one of:
modifying, with the processor, at least one of a speed, a direction, and a rate of travel of the VOP; and
halting, with the processor, movement of the VOP in a current position until the determined one or more possible collision events are resolved.

13. The method of claim 1, further comprising:
identifying, with the processor, a current state of a VAP section based on the plurality of environmental conditions and the first set of parameters obtained in real-time, wherein the current state comprises temporarily unavailable; and
actively launching, with the processor, one or more available VOPs to current location of the VAP section for validating the identified current state, re-determine the plurality of environmental conditions and re-transmit the first set of parameters in real-time, wherein the current state of the VAP section can be determined to either remain temporarily unavailable, or to be available again to be included in the creation of navigation plans.

14. The method of claim 1, further comprising:
detecting, with the processor, patterns, behaviors, and trends associated with the obtained first set of parameters, the plurality of environmental conditions, and one or more possible collision events;
training, with the processor, a dataset based on the detected patterns, behaviors and trends associated with the obtained first set of parameters, the plurality of environmental conditions, and the one or more possible collision events; and
tuning, with the processor, the dynamic properties and the one or more operational rules of the VOP based on the trained dataset.

15. The method of claim 1, further comprising:
continuously monitoring, with the processor, the first set of parameters obtained in real-time;
continuously monitoring, with the processor, the Virtual Approved Pathways (VAPs), the dynamic properties of the VOP and the one or more operational rules;
continuously monitoring, with the processor, the plurality of environmental conditions within the environment;
continuously monitoring, with the processor, the current position of the destination point, the predicted position of the destination point, and the possible movement of the destination point;
continuously training, with the processor, a dataset based on the monitored first set of parameters, the at least one VAP, the dynamic properties of the VOP and the one or more operational rules, the plurality of environmental conditions, the current position of the destination point, the predicted position of the destination point, and the possible movement of the destination point; and
updating, with the processor, a VAP database with the trained dataset, wherein the VAP database is maintained to store the dynamic properties, routes of the VAPs and operational rules associated with the VAPs.

16. The method of claim 1, wherein updating at least the portion of the optimal navigation plan based on the plurality of environmental conditions and the first set of parameters obtained in real-time comprises one of:
dynamically tuning, with the processor, one or more VAPs based on the obtained first set of parameters and the plurality of environmental conditions, wherein the one or more VAPs are pre-recorded using one of RTLS Tags and user-driven inputs, wherein the tuning comprises one of dynamically correcting, dynamically smoothening, dynamically straightening, dynamically aligning, and dynamically connecting the one or more VAPs; and
displaying, with the processor, parts of the one or more VAPs as visual highlights when the parts of the one or more VAPs are identified to be unsuitable.

17. The method of claim 1, wherein updating at least the portion of the optimal navigation plan based on the plurality of environmental conditions and the first set of parameters obtained in real-time comprises at least one of:
modifying, with the processor, at least one of: a route of the at least one VAP and the properties associated with the at least one VAP in real-time based on the determined plurality of environmental conditions; and
modifying, with the processor, a priority level assigned to the at least one VAP based on the determined plurality of environmental conditions.

18. The method of claim 1, wherein updating at least the portion of the optimal navigation plan based on the plurality of environmental conditions and the first set of parameters obtained the at real-time comprises:
generating, with the processor, one or more suggestions to correct at least one of multiple current VAPs, the properties, and the rules of a current VAP.

19. The method of claim 1, further comprising:
determining, with the processor, compatibility of the VOP for navigation by mapping the dynamic properties and the one or more operational rules of the VOP with the properties and rules of the at least one VAP; and
navigating, with the processor, the VOP, based on the determined compatibility, wherein the determined compatibility comprises one of directionality restrictions, speed limitations, distance maintenance from other objects, and a lane assignment within the at least one VAP.

20. The method of claim 4, wherein the sensor data is obtained by at least one of the one or more sensors carried by the one or more VOPs being directed by a control system, and the one or more sensors carried by other VOPs operating within the environment.

21. The method of claim 1, wherein the one or more operational rules comprise virtual approved pathway (VAP) rules, travel restrictive rules for specific classes of VOPs, traffic rules, event-based rules, environmental condition-based rules, activity-based rules, zone based rules, station-based rules, time-based rules, and pathway based rules, and wherein the one or more operational rules control behaviors of the one or more VOPs while navigating along respective one or more VAPs, wherein the one or more operational rules correspond to rules which the VOP is required to comply with, based on the rules which are applicable to the VOP along an optimal trajectory navigated by the VOP while performing a task of the one or more tasks.

22. The method of claim 4, further comprising:
evaluating, with the processor, one or more possible combinations between available VOPs, available VAPs, and possible trajectories within the environment, to decide which VOP of the available VOPs is best positioned to perform a task;
matching, with the processor, existing properties and rules associated with the available VAPs to properties and rules associated with the available VOPs and properties and rules associated with one of the task to be performed, one or more loads involved, one or more carts involved, and the plurality of environmental conditions existing and predicted at a time when the task is to be performed; and
determining, with the processor, the optimal trajectory for a best suited VOP to perform the task based on the matching.

23. The method of claim 4, wherein retrieving the one or more Virtual Approved Pathways (VAPs) within the environment from at least one of the one or more VOPs and the plurality of objects, comprises:
recording, with the processor, one or more VAPs by navigating the one or more VOPs within the environment.

24. The method of claim 1, further comprising:
automatically tuning pre-recorded pathways captured by at least one of RTLS tags or hand-drawn on a graphical user interface, wherein the tuning comprises at least one of automatically straightening, automatically smoothening, automatically aligning, and automatically connecting at least one of the pre-recorded pathways and the hand-drawn pre-recorded pathways; and
storing the automatically tuned pre-recorded pathways as one or more VAPs in a VAP database.
